(19) United States
(12) Patent Application Publication
(10) Pub. No.: US 2004/0012132 A1
(43) Pub. Date: Jan. 22, 2004

(54) Soft-start, soft-return gas spring

(76) Inventor: Ralph Roper, Indianapolis, IN (US)

Correspondence Address: Woodard, Emhardt, Moriarty, McNett & Henry LLP, Bank One Center/Tower, 111 Monument Circle, Suite 3700, Indianapolis, IN, 46204-5137, US

(21) Appl. No.: 10/601,971

(22) Filed: Jun. 23, 2003

Related U.S. Application Data
(63) Continuation-in-part of application No. 10/152,425, filed on May 21, 2002, now Pat. No. 6,622,831.
Application No. 10/152,425 is a continuation of application No. 09/783,634, filed on Feb. 14, 2001, now Pat. No. 6,390,457.

(51) Int. Cl. F16F 5/00

(52) U.S. Cl. 267/118; 267/64.15

(57) ABSTRACT

A gas spring includes an outer tube; a base plate; a head plate; an inner tube mounted to extend between the head plate and the base plate; a piston/rod assembly mounted to reciprocate vertically in the inner tube between a retracted, compressed position and an extended, rest position; a valve ring coaxially mounted around the rod to reciprocate between the main piston and head plate; a primary gas chamber; a relief chamber; seals for preventing fluid flow from the primary and relief chambers; a passageway providing communication between the primary gas chamber and relief chamber; and, valve apparatus for controlling fluid flow between the primary and relief chambers. The valve apparatus operates to open and close the fluid flow as a function of the position and direction of travel of the piston/rod assembly.

### REFERENCE TO RELATED APPLICATIONS

This application is a continuation-in-part of U.S. patent application Ser. No. 10/152,425 filed May 21, 2002, which is a continuation of Ser. No. 09/783,634 filed Feb. 14, 2001 now U.S. Pat. No. 6,390,457.

### FIELD OF THE INVENTION

The present invention relates to the field of gas springs, and specifically to a soft-start, soft-return gas spring for, among other things, cushioning the action of draw dies operating in stamping presses and the like.

### BACKGROUND OF THE INVENTION

For many years, double action or “toggle” presses were the industry standard for forming large metal parts such as automobile hoods. A toggle press has an outer ram that comes down and binds the blank to be formed. An inner ram with a punch having the desired part shape then follows through to draw the blank into a complementary shaped die cavity. In the quest for speed and efficiency, much of the industry is now using straightside or transfer presses, which are the forming presses to form the initial shape from the flat metal blank. Next, the part passes through a series of individual stations or presses to complete the necessary die operations, all in one combination process. Unfortunately, toggle presses are relatively slow and form the part in an inverted or upside down orientation. In most cases then, the toggle press will most likely have to include a turnover station following the draw operation. A solution to the speed and inversion problem is the use of the straightside press. Unlike the toggle press, where the outer ram comes down gently to bind the blank for drawing, straightside presses have but a single ram with an upper platen that is actuated by the throw of the press crank cycling at up to 30 strokes per minute and 30 or more inches of stroke. With a draw die mounted in the press, the die cushion or lower binder surrounds a lower punch, which defines the complementary part shape to the cavity of the upper die. The cushion floats around the punch and is supported in an up position upon a series of nitrogen gas springs that collectively offer adequate force to bind the blank for the draw operation. When the upper die binder face meets the floating cushion and blank, the blank is instantly contained between the upper and lower binder faces. The impact from the upper binder meeting the stationary die cushion is violent. The shock caused by this impact causes great damage to the press drive and creates undesirable pressure spikes in the individual cushion unit seals. After contact, because the ram force exceeds the resistance force of the gas cylinders, the ram, blank and cushion continue downward at the automatic press cycle speed until the they reach the bottom of the stroke, at which point the blank has been formed to the desired shape. At this point, the cushion cylinders have been compressed, and their resistive force has increased in accordance with the compression ratio of the nitrogen gas (Boyle's law). Cushion forces for major automotive dies commonly operate in the range of 200 to 300 tons. When the press ram reaches bottom position and starts its upstroke, the nitrogen gas cushion springs, with their intensified pressure, forces against the upper die throughout the die cushion upstroke. These forces cause major press drive damage, and stamping facilities have long been seeking a method to greatly reduce the cushion forces at the start of and throughout the upstroke so this intensified cushion force does not follow through and cause such damage. Thus, while gains have been made in speed and efficiency from the use of straightside presses versus toggle presses, the wear and tear inherent in the application of straightside presses continues to plague its users.

What is needed is a way to abate or eliminate the wear and tear resulting from the high impact and recoil effect inherent in straightside presses using nitrogen spring-loaded die cushions.

### SUMMARY OF THE INVENTION

Generally speaking, apparatus is provided for cushioning the action of draw dies operating in a straightside stamping press. The apparatus includes a soft-start, soft-return gas spring that provides a die cushion with highly reduced force when the press ram slams the die binders together, but quickly returns to proper binding of the blank for the balance of downstroke. Conversely, the ram returns to its upper position with a greatly reduced cushion resistance throughout the full upstroke.

A soft-start, soft-return gas spring includes an outer tube; a head plate connected to the top of the outer tube and defining a central opening; an inner tube mounted to extend downwardly from the head plate within the outer tube; a piston rod extending into the inner tube, through the central opening, the piston rod defining an inner trap and being mounted to reciprocate between a retracted, compressed position and an extended, rest position; an inner piston disposed between the inner tube and the piston rod to reciprocate within the inner trap; elements connected with at least one of the inner and outer tubes to define an outer trap; an outer piston disposed between the inner tube and the outer tube for vertical reciprocation within the outer trap; a primary gas chamber defined by the outer and inner tubes, outer and inner pistons, and piston rod; an outer oil chamber defined by the outer and inner tubes, outer piston and head plate; an inner oil chamber defined by the inner tube, inner piston, piston rod and head plate; wherein at least one of the head plate and the inner tube defines a valve passageway extending between the outer and inner oil chambers; a valve member disposed proximal the valve passageway and operable to variably control fluid flow between the inner oil chamber and the outer oil chamber; wherein the inner trap includes the inner piston having an upper position closing off the valve passageway; and, seals for preventing undesired fluid flow from the various chambers.

It is an object of the present invention to provide an improved gas spring.

Further objects and advantages will become apparent from the following description of the preferred embodiment.

### BRIEF DESCRIPTION OF THE DRAWINGS

FIG. 1 is a plan, diagrammatic view of a draw die 9 equipped with apparatus for cushioning the action of the die in accordance with the preferred embodiment of the present invention.

FIG. 2 is a side, elevational view, of the draw die 9 of FIG. 1 equipped with apparatus for cushioning the action of the die in accordance with the preferred embodiment of the present invention, and with portions thereof broken out in cross-section for clarity, and showing the die 9 in both open and closed positions.

FIG. 3 is side, cross-sectional view of a soft-start, soft-return gas spring 10 for use in applications such as the die 9 of FIG. 2 in accordance with the preferred embodiment of the present invention, and shown in the extended, rest position.

FIG. 4 is a side, cross-sectional view of the gas spring 10 of FIG. 3 shown in the retracted, compressed position.

FIG. 5 is an enlarged, side, and cross-sectional view of the valve ring valve 91 of the gas spring 10 of FIG. 4, shown in the retracted, compressed position.

FIG. 6 is a side, cross-sectional view of the gas spring 10 of FIG. 3 showing the piston/rod assembly 51 retracted from the extended, rest position about 0.3 inches (in one embodiment)—just enough to engage annular sealing ledge 71.

FIG. 7 is a side, cross-sectional view of the gas spring 10 of FIG. 3 showing the piston/rod assembly 51 retracted from the extended, rest position about 3 inches (in one embodiment) toward the retracted, compressed position.

FIG. 8 is a side, cross-sectional view of the gas spring 10 of FIG. 3 showing the piston/rod assembly 51 extended upwardly from the retracted, compressed position approximately 0.15 inches (in one embodiment) enough to separate flange 75 from annular sealing ledge 71.

FIG. 9 is a side, cross-sectional view of the gas spring 10 of FIG. 3 showing the piston/rod assembly 51 extended from the retracted, compressed position about 3 inches (in one embodiment) toward the extended, rest position.

FIG. 10 is a graph illustrating the optimum force output of a soft-start, soft-return gas spring, in accordance with the present invention, as a function of the movement of piston rod 57 from the extended, rest position (FIG. 3) to the retracted, compressed position (FIG. 4) and back.

FIG. 11 is a diagrammatic view of a manifold 105 for use in press and designed to receive modified soft-start, soft-return springs 106 in accordance with another embodiment of the present invention.

FIG. 12 is a side, cross-sectional view of a soft-start, soft-return spring 106 for use in the manifold 105 of FIG. 11.

FIG. 13 is a side, cross-sectioned view of a soft-start, soft-return gas spring 200 in accordance with another embodiment of the present invention.

FIG. 14 is an enlarged, cross-sectional view of the piston/rod assembly 205, valve ring 206, floating ring 209 and inner tube 202 of the soft-start, soft-return gas spring 200 of FIG. 13.

FIG. 15 is a side, cross-sectional view of a soft-start, soft-return gas spring 310 in accordance with another embodiment of the present invention.

FIG. 16 is an enlarged, cross-sectional view of the piston/rod assembly 332, valve ring 311, floating ring 330 and inner tube 202 of the soft-start, soft-return gas spring 310 of FIG. 15.

FIG. 17 is an enlarged cross-sectional view of a portion of the spring 310 of FIG. 16, focusing on the area of valve ring 311, floating ring 330 and piston rod 331.

FIG. 18 is a side, cross-sectional view of the soft-start, soft-return gas spring 310 of FIG. 15 and shown rotated 45° about its central axis.

FIG. 19 is an alternative embodiment of the configuration of FIG. 17.

FIGS. 20-27 are side, cross-sectional views of the soft-start, soft-return gas spring 310 of FIG. 15 and sequentially showing the position of valve ring 311, floating ring 330 and outer piston 211 in relation to movement of piston/rod assembly 332.

FIG. 28 is a graph illustrating the optimum force output of gas spring 310, in accordance with present invention, as a function of the movement of piston rod 332 from the extended, rest position (FIG. 15) to the retracted, compressed position (FIG. 23) and back.

FIG. 29 is a side, cross-sectional view of a soft-start, soft-return gas spring 400 in accordance with another embodiment of the present invention, and showing the right half of spring 400 in the extended, rest position, and the left half of spring 400 shown in the retracted, compressed position and rotated 90 degrees about center axis 408.

FIG. 30 is a top, plan view of the fixed valve ring 413 of gas spring 400 of FIG. 29.

FIG. 31 is a side, elevational view of the fixed valve ring 413 of FIG. 30.

FIG. 32 is a side, cross-sectional view of the fixed valve ring 413 of FIG. 30 taken along the lines 32-32 and viewed in the direction of the arrows.

FIG. 33 is a side, cross-sectional view of the fixed valve ring 413 of FIG. 30 taken along the lines 33-33 and viewed in the direction of the arrows, and showing poppit 467 in the up, valve closed position.

FIG. 34 is a side, cross-sectional view of the fixed valve ring 413 of FIG. 33, and showing poppit 467 in the down, valve open position.

FIG. 35 is a graph illustrating the optimum force output of gas spring 400, in accordance with the present invention, as a function of the movement of piston rod 406 from the extended, rest position to the retracted, compressed position and back.

### DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, and that any alterations or modifications in the illustrated device, and any further applications of the principles of the invention as illustrated therein are contemplated as would normally occur to one skilled in the art to which the invention relates.

Numerical values provided herein for certain dimensions, weights, pressures and other characteristics are for purposes of describing a particular embodiment. It should be understood that such values will vary with the type and size of the part to be formed and with the desired operating characteristics of the corresponding press and/or gas spring.

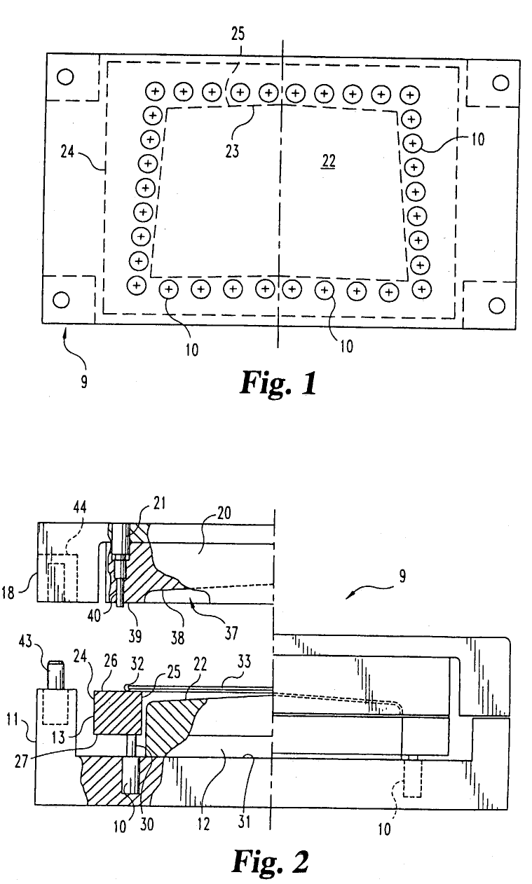

Referring now to FIGS. 1 and 2, there is shown a draw die 9 operable within a straightside press equipped with soft-start, soft-return gas springs 10 for cushioning the action of the die in accordance with the preferred embodiment of the present invention. Die 9 generally includes a lower die shoe 11, a punch 12, a pad or “cushion” 13, a plurality of soft-start, soft-return gas springs 10, an upper die shoe 18, upper die 20, and a set of hydraulic shock absorbers 21. As with other presses of this type, punch 12 is fixedly mounted to lower shoe 11 and has a top surface 22 which defines the desired shape of the part to be formed. For purposes of discussion of the current embodiment, and as seen by the plan view outline 23 of punch 12 (FIG. 1), the part intended to be formed by die 10 is an automobile hood. The present invention is not intended to be limited to the formation of hoods, or of auto parts. Further, the gas spring 10 of the present invention is contemplated to have applications outside of the stamping industry.

Cushion 13 is a ring that encircles punch 12 and has an outer surface 24, an inner surface 25, an upper surface 26 and a lower surface 27. Cushion 13 thus defines a central hole that is bounded by inner surface 25 and through which extends punch 12. The outer profile of cushion 13, in overall plan view, is rectangular, as shown by the outline of outer surface 24 (FIG. 1) and the inner profile defined by inner surface 25 in plan view has the same shape as the plan view shape (at 23) of punch 13. Upper and lower surfaces 26 and 27 are parallel to each other and orthogonal to outer and inner surfaces 24 and 25. Cushion 13 is thus sized to reciprocate vertically around punch 12, but is held floating in the up and rest position (as seen in the left half of FIG. 2) by the plurality of gas springs 10. Each of the gas springs 10, as will be described in greater detail herein, is a nitrogen gas spring with a piston rod 30 that may reciprocate between a retracted, compressed position and an extended, rest position. In the rest position, piston rod 30 extends about 6 inches from the surface 31 of lower shoe 11. In its compressed position (right half of FIG. 2), piston rod 30 is flush or extends just slightly above surface 31.

A plurality of lock beads or draw beads 32 for binding a blank 33 extend upwardly from upper surface 26, proximal to inner surface 25, and thus surround punch 12. Gas springs 10 are sized so that, in the rest position, piston rods 30 support cushion 13 high enough so that its upper surface 26 is approximately one inch above the highest point on punch 12. That is, in the rest position, a blank 33 may be positioned over punch 12 and supported around its periphery by beads 32 of cushion 13, as shown in the left side of FIG. 2. Depending on the size of the blank and on the profile of the punch, blank 33 will not touch punch 12 in this rest position, prior to the descent of the upper die 20. The plurality of the gas springs 10 sit within cavities in lower die shoe 11 in a spaced relationship around punch 12 and under cushion 13. In the present embodiment, there are 34 gas springs 10.

Upper die 20 defines a cavity 37 with an inner surface 38 that mates with the top surface 22 of punch 12 to define the shape of the part to be formed. Upper die 20 also defines a lower, planar surface 39 and is mounted to the underside of upper die shoe 18 which is mounted to a ram (not shown) which drives shoe 18 and upper die 20 down against cushion 13 and punch 12 to form the desired part. The set of hydraulic shock absorbers 21 comprises four shock absorbers 21 that are mounted at the corners of upper die 20. Each shock absorber 21 engages with a plunger or adapter 40 that extends one inch below lower planar surface 39. The purpose for using shock absorbers is to start the down motion of the cushion before the binders impact. Lower die shoe 11 has four guide posts 43, one extending upwardly from each of its corners, and upper die shoe 18 has a corresponding bushing 44 at each of its corners, each bushing sized to receive a guide post therein to ensure alignment between upper shoe 18 and lower die shoe 11 when the two are brought together.

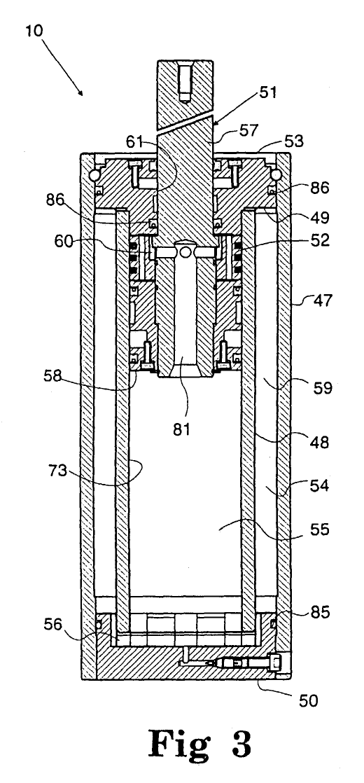

Referring to FIGS. 3 through 5, there is shown a soft-start, soft-return gas spring 10 in accordance with the preferred embodiment of the present invention. Gas spring 10 is in the shape of a cylinder and generally includes an outer tube 47, an inner tube 48, a head plate 49, a base plate, 50, a piston and rod assembly 51, a valve ring 52, an end cover 53, and various seals, wear bands, scrapers, snap rings and lock rings as are commonly known to properly assemble and seal such gas and similar springs and cylinders. Outer tube 47 is cylindrically-shaped and has an inner diameter. Base plate 50 forms the bottom of the gas spring cylinder. Annular-shaped head plate 49 forms the top of the cylinder and has a central opening with an inner cylindrically-shaped wall 61. Inner tube 48 is also cylindrical, having an outer diameter and an inner diameter, and is mounted to extend between head plate 49 and base plate 50, coaxially within outer tube 47.

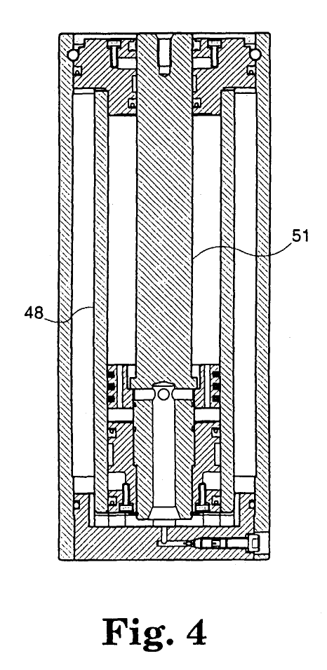

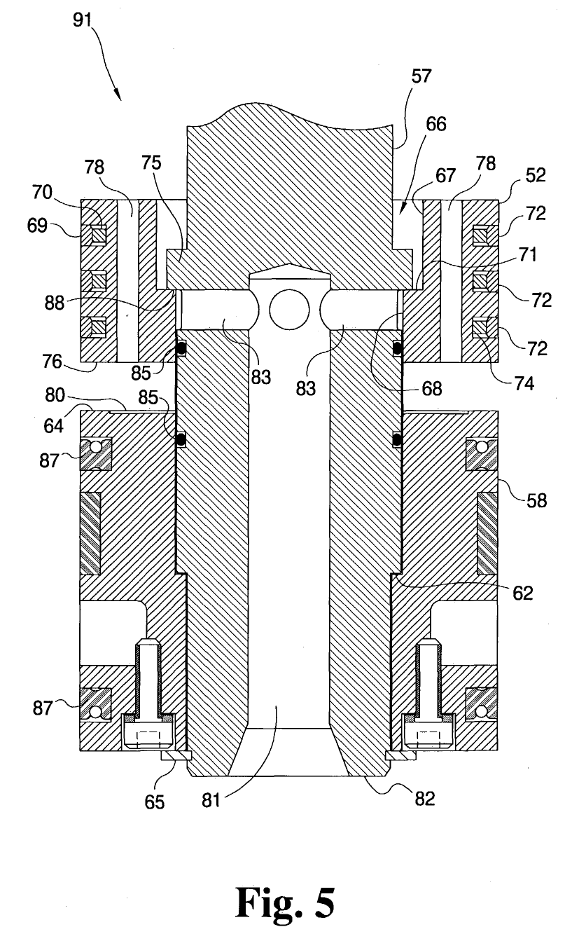

Piston/rod assembly 51 comprises a piston rod 57 and a main piston 58. Piston rod 57 has sections of different outer diameters which produce a ledge (at 62), and main piston 58 has sections of different inner diameters that correspond to the outer diameters of piston rod 57, which produce a complementary ledge (at 62), and which together produce a close tolerance telescopic fit between piston rod 57 and main piston 58. The ledges (at 62) of piston rod 57 and main piston 58 engage to define the upper limit of main piston 58 on piston rod 57, and main piston 58 is secured thereat by a heavy duty snap ring 65 that seats within an annular groove in the bottom of piston rod 57. Piston/rod assembly 51 is coaxially mounted to vertically reciprocate within inner tube 48 between an extended, rest position (FIG. 3) and a retracted, compressed position (FIG. 4). The rest position includes the piston rod 57 of piston/rod assembly 51 extending through the inner cylindrically-shaped wall 61 of head plate 49 and upwardly of head plate 49. A primary gas chamber 59 is defined by outer tube 47, inner tube 48, head plate 49, base plate 50, and inner piston/rod assembly 51. The lower end of inner tube 48 is provided with appropriate openings 56 such that the region 54 between head and base plates 49 and 50 and between outer and inner tubes 47 and 48 is in communication with the region 55 between piston 58 and base plate 50 and within inner tube 48. That is, because of openings 56 in the bottom of inner tube 48, regions 54 and 55 together comprise primary gas chamber 59. Such communication between regions 54 and 55 may be accomplished in other manners, for example by openings or passageways defined in base plate 50. A relief chamber 60 is defined and bounded by the inner wall of inner tube 48, piston rod 57, the bottom 63 of head plate 49, and the upper face 64 of piston 58. Referring to FIG. 5, valve ring 52 is annular with a central opening 66 defined by inner cylindrical walls 67 and 68 that have different diameters. The transition between walls 67 and 68 is an annular sealing ledge 71. Valve ring 52 is disposed above main piston 58 and is provided with braking seals 72 disposed within annular grooves 74 to engage with the inner wall 73 of inner tube 48. Braking seals 72 are seals, but their function is to offer resistance to axial movement. That is, they maintain a desired outward force component, and have a sufficiently high coefficient of friction with the lubricated inner wall 91, so as to produce a friction force that resists, to the desired extent, axial movement relative to inner tube 48. In one embodiment, braking seals 72 are G-Ring 510 Series TFE Piston Seals (material no. 808) available from Zatkoff Seals & Packings, 9334 Castlegate Drive, Indianapolis, Ind. Each seal 72 comprises a fiberglass reinforced TFE outer piston ring 69 and an inner nitrile expander ring 70. The Durometer of the expander ring 70, and/or the inner and outer radii of the expander ring 70, can be selected to produce a desired resistance to axial movement. The present embodiment shows three braking seals 72, but it is believed that two braking seals 72 would be preferred.

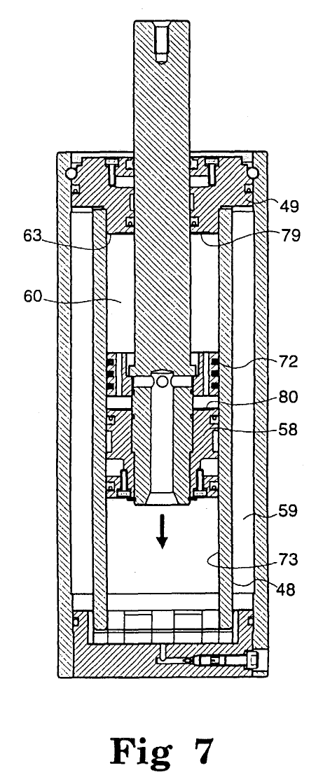

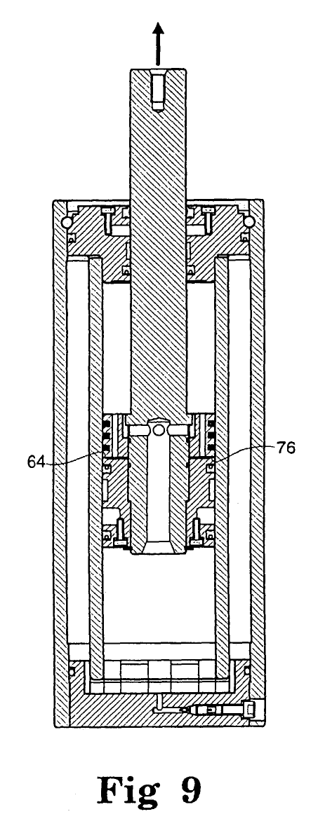

Piston rod 57 extends through central opening 66, and valve ring 52 thereby coaxially reciprocates along piston rod 57, but within a trap defined by the piston/rod assembly 51. The trap includes a flange 75 that extends radially outwardly from piston rod 57 a desired distance above main piston 58. The outer diameter of flange 75 is less than the inner diameter of upper wall 67 and greater than the inner diameter of lower wall 68. Valve ring 52 is thus constrained to move within the trap from a lower extreme where the bottom 76 of valve ring 52 engages the top surface 64 of piston 58 (FIGS. 3 and 9), and an upper extreme where the sealing ledge 71 engages with the disc-shaped valve seal 88 of flange 75 (FIGS. 4-7). Piston rod 57, main piston 58 and valve ring 52 are sized, configured and assembled in one embodiment so that the trap constrains valve ring 52 to a maximum range of vertical movement of 0.3 inches between upper and lower extremes. In the present embodiment the trap is formed, in part, by the integrally formed flange 75 extending from piston rod 57. Other configurations are contemplated, however, to control the range of movement of the valve ring to cut off or modulate the fluid flow between the primary and relief chambers 59 and 60. Purely by way of example, either or both ledge 71 or flange 75 could be replaced by a ring held by valve ring 52 or piston rod 57. Also, such ledge, flange, ring or other combination could be sized and configured to interact with the valve ring to limit the valve ring's travel and to control the gas flow, either directly by blocking off the passageway between the primary and relief chambers 59 and 60, or indirectly by engaging another type of seal mechanism that controls fluid flow in such passageway.

Vent holes 78 are defined to extend vertically through valve ring 52, and disc-shaped recesses 79 and 80 are defined in the bottom surface 63 of head plate 49 and the top surface 64 of piston 58, all to ensure that the gas pressure in relief chamber 60 will be maintained even in the full up (extended, rest) position of the piston.

Piston rod 57 defines a central passageway 81 extending from its lowermost surface 82 up to just below flange 75. One or more radial passageways 83 extend radially from central passageway 81, just below flange 75, and to the outer, cylindrical surface of piston rod 57. Appropriate seals, such as at 85, 86 and 87 (FIGS. 3 and 5), are provided to constrain fluids within the chambers identified herein.

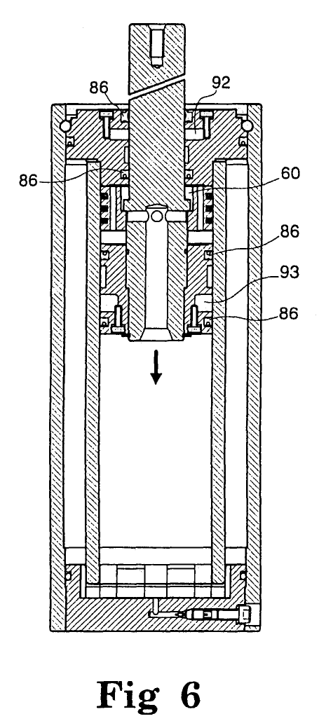

In operation, from the extended, rest position shown in FIG. 3, when piston rod 57 travels downward the first 0.3 inches, valve ring 52 remains in full-up position, topped out against the bottom of head plate 49, as shown in FIG. 6. At this point, valve chamber 60 is very small and is no longer in communication with primary gas chamber 59. At this 0.3 inch downstroke position, annular flange 75 of piston rod 57 seats its lower face against annular sealing ledge 71 of valve ring 52, thus creating a valve ring valve 91 that is in its closed position (FIGS. 5 and 6). From this point and all the way through the remainder of the downstroke to the retracted, compressed position (FIG. 4), the braking action of braking seals 72 contributes a sufficient frictional force component to keep flange 75 seated in a sealing relation against ledge 71, and valve ring valve 91 stays closed.

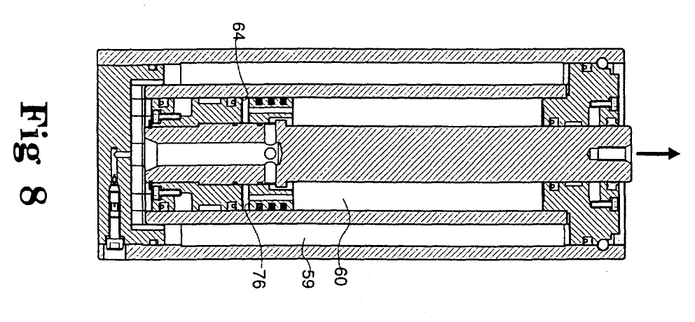

At the start of the upstroke (from the retracted, compressed position of FIG. 4) as the load is removed from the top of piston rod 57, piston/rod assembly 51 rises, and flange 75 disengages from valve ring 52. This is shown in FIG. 8 where piston/rod assembly 51 has risen approximately 0.15 inches (in the present embodiment). As soon as flange 75 lifts away from annular sealing ledge 71, communication is again provided through passageways 81 and 83 between the primary and relief chambers 59 and 60. As main piston 58 continues to rise, its top surface 64 engages with the bottom surface 76 of valve ring 52 (FIG. 9) and pushes it to full upstroke position (FIG. 3). At this point, flange 75 is again 0.3 inches above the seat position on annular sealing ledge 71 of valve ring 52.

The three gas chambers are: (1) outer chamber (region 54), (2) the chamber under the piston (region 55), and (3) the chamber that develops above the piston as the piston strokes downward (relief chamber 60). The outer chamber 54 and the chamber 55 beneath the piston are permanently interconnected such that the gas beneath the piston simply displaces into the outer chamber 54 that serves as a surge tank. The volume ratio of the gas below the piston (including the volume of the outer chamber 54) with the piston rod stroked full out (FIG. 3) vs. the rod stroked full in (FIG. 4) is in this case 1.58 to 1. This ratio is approximately the same as existing industrial gas springs. Important to the success of the gas spring 10 of the present invention is the technique of controlling the flow of gas below main piston 58 into the chamber above main piston 58. When the gas pressure is normalized between the chamber above main piston 58 and the chamber below main piston 58, the net force of main piston 58 reduces to the piston rod area times the gas pressure in such chambers. In the model illustrated herein, this force drops immediately (i.e., within 0.15 inches of upstroke) to about 16% of the downstroke force. Controlling the gas flow is accomplished by providing ports through the lower end of the piston rod 57 that interconnect the chambers above and below main piston 58. The valve ring 52 operates as a check valve that opens and closes the ports interconnecting the chambers 59 and 60 at the appropriate times to optimize the cushion force of the gas spring 10, but also to significantly reduce the pressure when it can be most damaging to the die or other machinery or components with which it interacts.

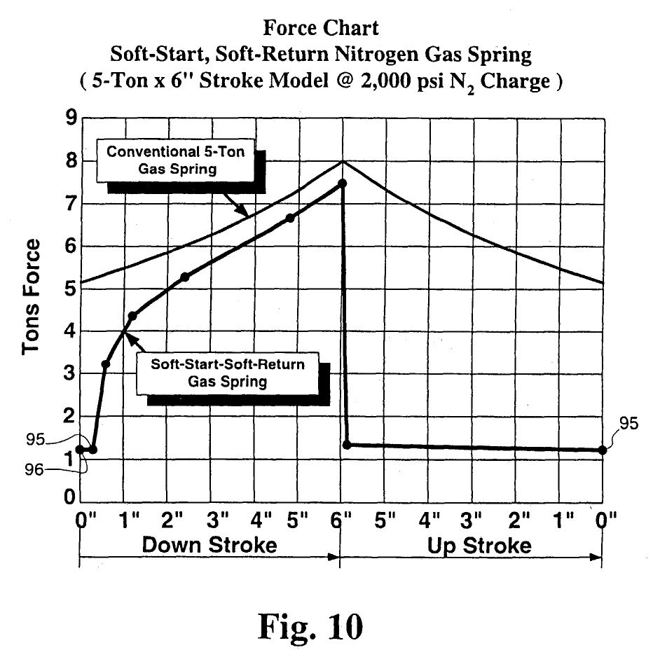

At full upstroke position (the extended, rest position of FIG. 3), the interconnecting ports are open allowing the gas pressure above and below main piston 58 to be in equilibrium, which renders the net force for the first 0.3 inches of downstroke to be only the cross-sectional area of the piston rod 57 times the gas pressure. However at precisely 0.3 inches downstroke (FIG. 6) the projecting flange 75 of piston rod 57 seats against the seal face of ledge 71, thereby sealing off any further gas flow from the chamber below the principal piston. From this point throughout the remainder of the downstroke, valve ring valve 91 is closed. This causes the net force of the unit to be the entire cross-sectional area of the main piston face times the gas pressure (minus the effect of the fast decaying pressure of the 0.3 inches high column of gas that was above the piston before the seal faces contacted). Shown in FIG. 10 is a force graph illustrating the optimum force output of a soft-start, soft-return gas spring, in accordance with the present invention, as a function of the movement of piston rod 57 from the extended, rest position (FIG. 3) to the retracted, compressed position (FIG. 4) and back. The graph incorporates Boyle's law, which states that, when the temperature is kept constant, the volume of a given mass of an ideal gas varies inversely with the pressure to which the gas is subjected. The computations were based on stroke increments starting at 0.3 inches and progressing through 0.6 inches, 1.2 inches, 2.4 inches, 4.8 inches and 6.0 inches of downstroke. FIG. 10 also shows the force vs. stroke relation for a conventional gas spring.

FIG. 10 shows the force development for the entire downstroke and the importance of the “soft-start” feature. As can be seen, the downstroke force starts out low, but with sufficient binding tonnage, it smoothly transitions to full tonnage, thereby resulting in a “soft-start.” As previously noted, the gas compression ratio for the stroke-out vs. the stroke-in positions is about 1.58 to 1 for the unit illustrated herein. This means that a unit pre-charged to 2,000 psi will elevate to approximately 1.58×2,000 or about 3,100 psi at the bottom of the down-stroke. As can be seen in FIG. 10, the shape of the downstroke force curve for the conventional unit is very different. The conventional unit starts out abruptly at nearly full force.

Perhaps of greater importance is the “soft-return.” A rapid decline in the upward force is accomplished by the valve ring valve 91 starting to open instantly as piston/rod 51 starts upwardly, causing the gas pressure to normalize above and below main piston 58. The reduced force is due to combined effect of reduced gas pressure and reduced effective surface area. Reduced gas pressure results from the volume added above the valve ring when the valve seat opens. Moreover, when the valve opens, the area upon which the gas pressure is acting reduces from the full cross-sectional area of the piston to only that of the rod. The combined result of these two features is that the output force is rapidly relieved near the beginning of the upstroke.

Gas spring 10 is also provided with self-lubricating oil cavities 92 and 93 (FIG. 6) which contain an amount of lubricating oil to keep piston rod 57 and main piston 58 constantly lubricated within their cylinders of travel. Cavities 92 and 93 are each flanked by seals 86.

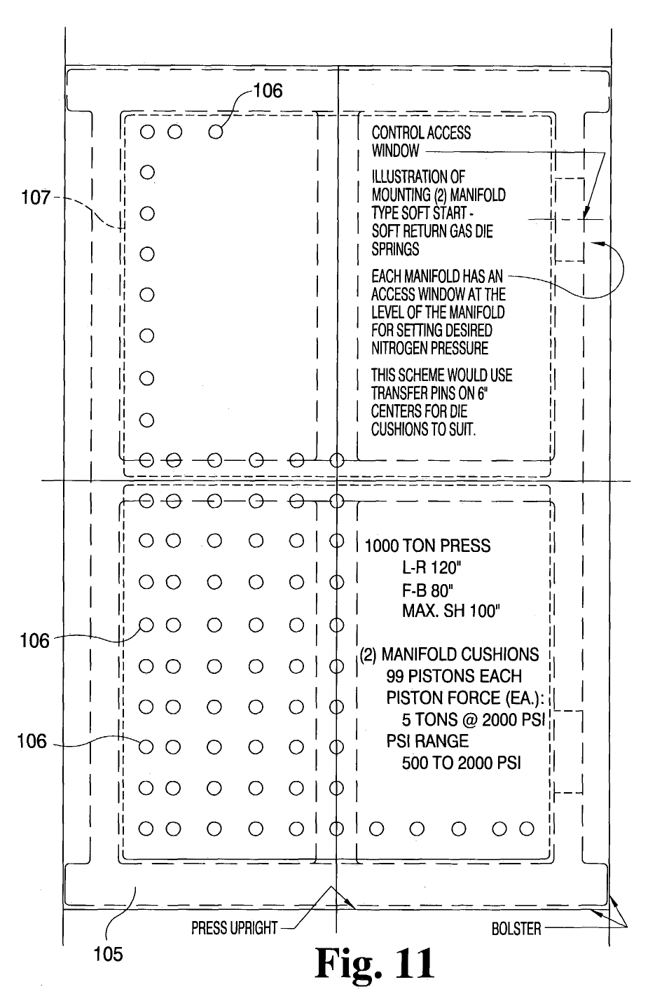

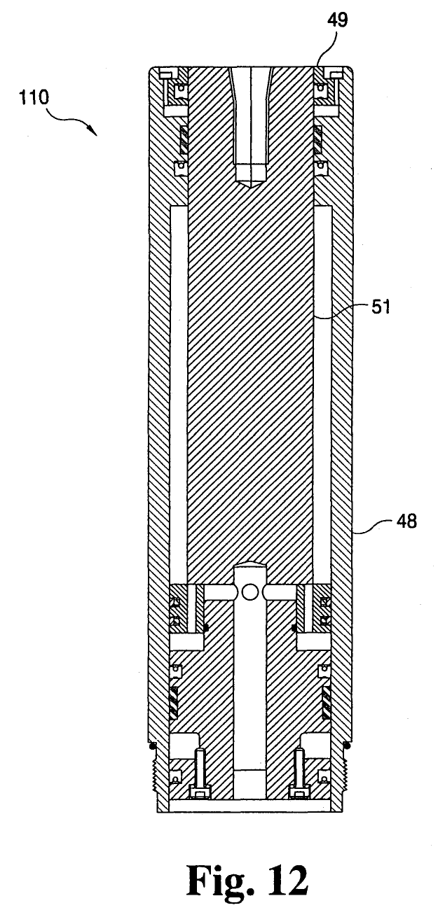

The above described embodiment is a single, self-enclosed unit capable of being used individually or being one of many such units in a particular application, such as shown in the straightside press of FIGS. 1 and 2. Alternative embodiments are contemplated wherein the soft-start, soft-return gas spring is constructed instead to operate as one of a network of units where the primary chambers are connected in parallel. One such configuration includes a plurality of the gas springs 10 and hoses or comparable connection apparatus to connect the primary chambers 59 of all the gas springs 10 together to be in common communication with each other. Another configuration shown in FIG. 11 includes providing a common manifold 105 with an interior chamber 107 and a plurality of ports 106, each port 106 in communication with such chamber and sized and configured to receive one gas spring. Such gas spring 110 is substantially the same as that that of FIG. 3 except that it would consist of the piston/rod assembly 51, head plate 49, inner tube 48 and valve ring 52 (FIG. 12). The inner tube 48 of each gas spring 110 would connect as by screwing into the port 106 of manifold 105. The manifold 105 would provide the additional volume (akin to a surge tank) for the plurality of gas springs 110 that the outer region 54 provides for the individual gas spring 10 of FIG. 3.

Alternative embodiments are also contemplated wherein soft-start, soft-return gas springs 10 and 200 (as described in the following alternative embodiment) are used in machines other than the press disclosed here. It is also contemplated that shock absorber 21 could be an option since its function is to further reduce the impact over and above the reduced impact attributed to the soft-start feature.

The minimum output force of the gas springs 10 in the extended, rest position (FIG. 3) at which contact is first made by the upper binder is indicated at 95 in FIG. 10. This output force remains substantially the same through the first 0.3 inches of travel of the piston/rod assembly 51 from the extended, rest position, as shown in FIG. 6 and is indicated at 96 in FIG. 10. This minimum output force may be varied as desired by varying the volume of the relief chamber 60, which may be done in one manner by varying the diameter of piston rod 57.

The present invention is primarily designed for use as a gas spring, the preferred gas being nitrogen. It is contemplated, however, that spring 10 could be adapted for use with a compressible liquid.

As discussed herein, the invention provides users of existing commercial gas springs the option to convert to the soft-start, soft return gas spring 10 for many or all existing applications. This is feasible since the physical shut height and girth of this new spring is compatible with existing gas springs. Such applications include, but are not limited to:

a) free standing drop-in units;

b) plate-mounted cluster units interconnected with tubular gas lines with a common fill port;

c) manifold units in which a cluster of gas springs are mounted into a manifold that contains a network of gas passageways interconnecting with the gas springs mounted thereon in which a common fill port is provided on the manifold

d) a full range of flange mounting applications.

Language is used herein to indicate structural and operational relationships. It is to be understood, however, that alternate configurations are contemplated as would occur to one skilled in the art. For example, “vertical” is used herein to describe reciprocation of pistons within the gas spring 10 when it is oriented as shown in the corresponding drawings. It is nevertheless understood that the cushion unit could operate along a non-vertical axis (e.g. a horizontal axis), for example, and the piston action would consequently also be along the same non-vertical axis (horizontal).

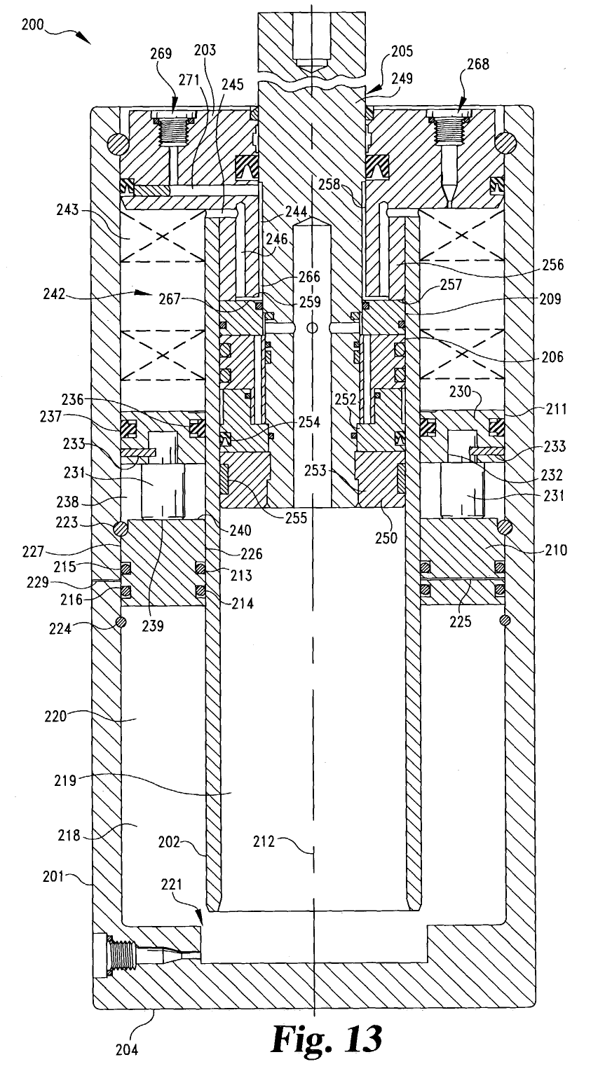

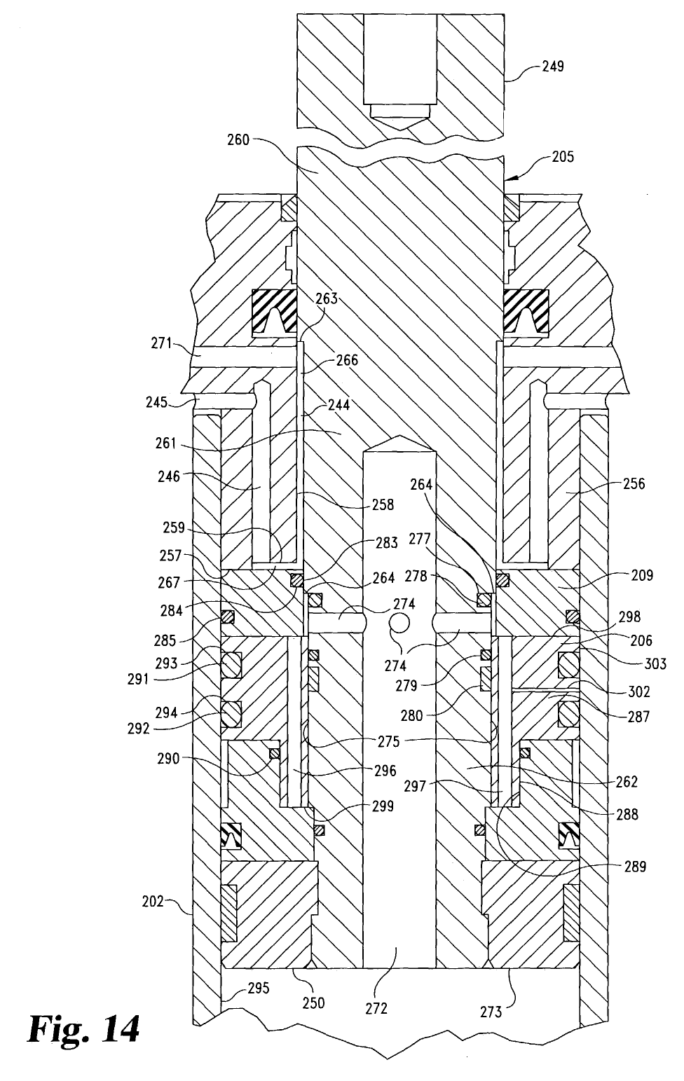

Referring to FIGS. 13 and 14, there is shown a soft-start, soft-return gas spring 200 in accordance with another embodiment of the present invention. Like gas spring 10 of FIGS. 3-5, gas spring 200 generally includes an outer tube 201, an inner tube 202, a head plate 203, a base plate 204, a piston/rod assembly 205, a valve ring 206, and various seals, wear bands, scrapers, snap rings and lock rings as are commonly known to properly assemble and seal such gas and/or hydraulic springs and cylinders. In addition, gas spring 200 further includes a floating ring 209, an outer chamber barrier 210 and an outer piston 211, and defines a central axis 212. The various seals, wear bands, scrapers, snap rings and lock rings that are contemplated by the present embodiment and others disclosed herein are shown in the accompanying figures, and many are specifically pointed out. Other embodiments are contemplated wherein the number, size, configuration, type and location of such seals, wear bands, scrapers, snap rings and lock rings are varied as necessary or desired to achieve the operation and purpose of the present invention as described and understood herein.

Outer chamber barrier 210 is generally a toroidal-shaped ring and is disposed between inner and outer tubes 202 and 201, respectively. Inner, upper and inner, lower o-rings 213 and 214, respectively, and outer, upper and outer, lower o-rings 215 and 216, respectively, are seated within recesses defined in outer chamber barrier 210 and are to prevent fluid flow between chambers above and below outer chamber barrier 210. An outer gas chamber region 218 is bounded generally by outer chamber barrier 210, outer tube 201, inner tube 202 and base plate 204. An inner gas chamber region 219 is bounded generally by piston/rod assembly 205, inner tube 202 and base plate 204. Inner and outer gas chamber regions 218 and 219 are in mutual communication via a gap 221 between the bottom of inner tube 202 and base plate 204. Inner and outer gas chamber regions 219 and 218 together comprise the primary gas chamber 220. Outer chamber barrier 210 is constrained to limited vertical movement by upper and lower lock rings 223 and 224, respectively, that are received within recesses defined in outer tube 201, as shown. In initial assembly, lower lock ring 224 will define a bottom position for outer chamber barrier 210. Charging primary gas chamber 220 with gas (i.e. N₂) will force outer chamber barrier up against upper lock ring 223, where it will reside during operation of a fully charged gas spring 200. A vent passageway 225 extends radially all the way through one side of outer chamber barrier 210. Vent passageway 225 is vertically disposed between the upper o-rings 213 and 215 and the lower o-rings 214 and 216, to provide communication between the inner cylindrical surface 226 of barrier 210 and the outer cylindrical surface 227 of barrier 210. An exhale passageway 229 is defined in outer tube 201 to horizontally align with vent passageway 225—and more particularly, anywhere between upper and lower o-rings 215 and 216—when gas spring 200 is charged and outer chamber barrier 210 is positioned at its upper extreme against upper lock ring 223, as shown.

Outer piston 211 includes a generally toroidal-shaped ring 230 and four, identical spacer pins (two of the four shown at 231). The four spacer pins 231 are disposed 90° apart about central axis 212. The upper portion of each spacer pin 231 is received within a hole 232 defined in the underside of ring 230, and is secured thereat by a lock pin 233. Inner and outer annular seals 236 and 237, respectively, are received within recesses defined in outer piston 211, as shown. Seals 236 and 237 are of the same type as braking seals 72 (FIG. 5), except seals 236 and 237 are selected with characteristics, not to provide a certain braking action, but rather to exert as little resistance to movement of piston 211 as possible, while at the same time providing sufficient sealing action to prevent fluid flow between the chambers above and below outer piston 211. Thus, in one embodiment, seals 72 of spring 10 (FIG. 3) might exert an axial friction force of approximately 80 lb_{f}, while seals 236 and 237 would only exert an axial friction force of approximately 5 lb_{f}. Outer piston 211 is disposed between inner and outer tubes 202 and 201, respectively, for vertical sliding movement between head plate 203 and outer chamber barrier 210. A control gas chamber 238 is thus defined by inner and outer tubes 201 and 202, outer chamber barrier 210 and outer piston 211. The lower limit of movement of outer piston 211 is defined as the bottoms 239 of pins 231 engage the top surface 240 of outer chamber barrier 210.

Gas spring 200 defines a primary oil chamber 242 that includes an outer oil chamber 243 and an inner oil chamber 244. Outer oil chamber 243 is generally bounded by outer and inner tubes 201 and 202, head plate 203 and outer piston 211. Outer oil chamber 243 communicates with an inner oil chamber 244 through slots or passageways 245 and passageways 246 defined in head plate 203, as are described below.

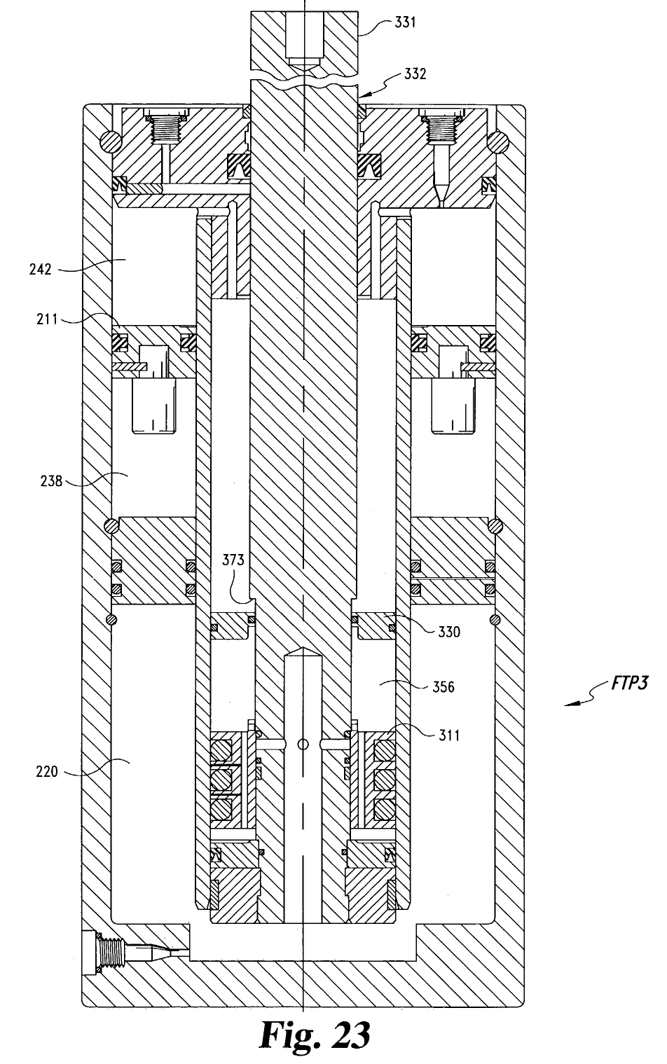

Like piston/rod assembly 51 of FIG. 3, piston/rod assembly 205 comprises a piston rod 249 and a main piston 250 that are sized, configured and assembled to reciprocate as a unit within inner tube 202 between an extended, rest position (FIG. 13) and a retracted, compressed position (FIG. 23). In the embodiment of FIG. 13, main piston 250 is shown comprising upper and lower piston heads 252 and 253 that are sized to matingly fit together and, with piston rod 249, to form a unitary-acting unit. At least upper piston head 252 is contemplated to comprise two halves that are brought and held tightly together on opposite sides of piston rod 249 by a close fit within inner tube 202. An appropriate seal 254 and wear band 255 are disposed in corresponding recesses defined in upper and lower piston heads 252 and 253, respectively. Other configurations are contemplated, such as one where piston/rod assembly 205 is an integrally formed unit.

Head plate 203 includes a generally cylindrical projection 256 that, in assembly, extends down into the top of inner tube 202. Vertical passageways 246 extend up from the bottom 257 of projection 256 to connect with radial slots or passageways 245 that extend from there, outwardly of projection 256 and to communicate with outer oil chamber 243. Head plate 203 defines a central passageway 258 through which extends piston rod 249. Head plate projection 256 defines a generally annular recess 259 in its bottom 257. Recess 259 extends from central passageway 258 outwardly at least far enough to communicate with vertical passageways 246.

The upper portion of piston rod 249 has a primary diameter at 260 (FIG. 14) and, therebelow, has first and second reduced diameter portions 261 and 262 that define first and second circumferential ledges at 263 and 264. With piston/rod assembly 205 in the extended, rest position of FIGS. 13 and 14, inner oil chamber 244 is at its mimimum volume and comprises the generally cylindrically-shaped first oil chamber region 266 and the generally annular-shaped second oil chamber region 267. First oil chamber region 266 is defined below ledge 263, above floating ring 209 (which is up against the bottom 257 of head plate 203) and between the inner surface of central passageway 258 and the outer surface of piston rod 249 at the reduced diameter region 261. Second oil chamber region 267 is the volume generally bounded by inner tube 202, piston rod 249, floating ring 209 and head plate 203 and of annular recess 259. With piston/rod assembly 205 in the extended, rest position (FIG. 14), second oil chamber 267 essentially comprises just the volume of annular recess 259. Head plate 203 also includes an oil fill port 268 and a relief port 269, as well as a relief passageway 271 that leads from relief port 269 to first oil chamber region 266, as shown. The total volume of oil held in the primary oil chamber 242 thus comprises the sum of oil held in inner and outer oil chambers 243 and 244, as well as the connecting passageways 245, 246 and 271 and fill and relief ports 268 and 269.

Piston rod 249 defines a central passageway 272 extending from its lowermost surface 273 up to at least about the second circumferential ledge 264. One or more radial passageways 274 extend radially outwardly from central passageway 272, a short distance below ledge 264 and to the outer, cylindrical surface 275 of piston rod 249 at the second reduced diameter portion 262. An annular recess 277 is defined in piston rod 249, the upper surface of which is coplanar with second circumferential ledge 264. A seal 278 is seated within recess 277. Radial passageways 274 are defined below recess 277 and seal 278, as shown. A seal 279 and a wear band 280 are disposed in recesses defined in piston rod 249 below radial passageways 274, as shown, to seal against and engage with valve ring 206.

Alternative embodiments are contemplated wherein the recess 277 and seal 278 contained therein are shaped, sized and/or located differently than shown in FIGS. 13 and 14. The particular sealing arrangement provided by recess 277 and 278 may be provided in any suitable manner so long as valve ring 206 effectively seals off the passageways 274 at the desired positionment of valve ring 206 relative to piston rod 249.

Floating ring 209 is generally a toroidal-shaped ring with a rectangular cross-section, is disposed between inner and outer tubes 202 and 201, respectively, and is disposed directly below the cylindrical projection 256 of head plate 203. An inner seal 283 is disposed in a recess 284 defined in the upper, inner portion of floating ring 209 such that, in the extended, rest position of FIGS. 13 and 14, seal 283 is juxtaposed above ledge 264 to seal against fluid flow between the oil-filled chamber above seal 283 and the gas-filled chamber below seal 283. An outer seal 285 is also provided in a recess in the outer surface of floating ring 209 to seal between floating ring 209 and inner tube 202, as shown.

Valve ring 206 is a toroidal-shaped ring disposed between inner and outer tubes 202 and 201, respectively, and between floating ring 209 and main piston 250. Valve ring 206 has an inner diameter substantially equal to the outer diameter of piston rod 249 at its second reduced diameter portion 262. The outer diameter of valve ring 206 at its upper, primary portion 287 is substantially equal to the inner diameter of inner tube 202. Below primary portion 287, valve ring 206 has a reduced outer diameter, which creates a generally cylindrical, downwardly extending flange 288. Main piston 250 defines a cylindrical well 289 between itself and piston rod 249, well 289 being shaped and sized to telescopically receive the complementary-shaped cylindrical flange 288 therein. A seal 290 is provided—between piston 250 and flange 288, as shown in FIG. 14, to prevent fluid flow thereat. Floating ring 209 is constrained to travel, relative to piston rod 249, between first circumferential ledge 263 at the top and valve ring 206 at the bottom. Valve ring 206 is constrained to travel, relative to piston rod 249, between piston 250 at the bottom and either floating ring 209 or second circumferential ledge 264 at the top (depending on the position of piston/rod assembly 205).

Valve ring 206 is provided with braking seals 291 and 292 disposed within annular grooves 293 and 294, respectively, to engage with the inner wall 295 of inner tube 202 to exert a braking force against axial movement of valve ring 206 relative to inner tube 202. Braking seals 291 and 292 are contemplated to be the same type as braking seals 72 of gas spring 10, or they may be other types, so long as they exert the desired axially directed force resistive to axial movement of valve ring 206 within inner tube 202. A plurality of vent passageways (two shown at 296 and 297) are defined to extend vertically from the top surface 298 of valve ring 206, down through cylindrical flange 288 and to the bottom annular surface 299 of flange 288, to ensure that the gas pressure remains the same both above and below valve ring 206 (inside of seal 290). At least one, small-diameter vent passageway 302 extends radially through valve ring 206 to provide fluid communication between at least one vent passageway (e.g. 297) and the outer surface 303 of upper primary portion 287 of valve ring 206. This helps prevent a pressure imbalance that might develop between braking seals 291 and 292 during operation and maintenance.

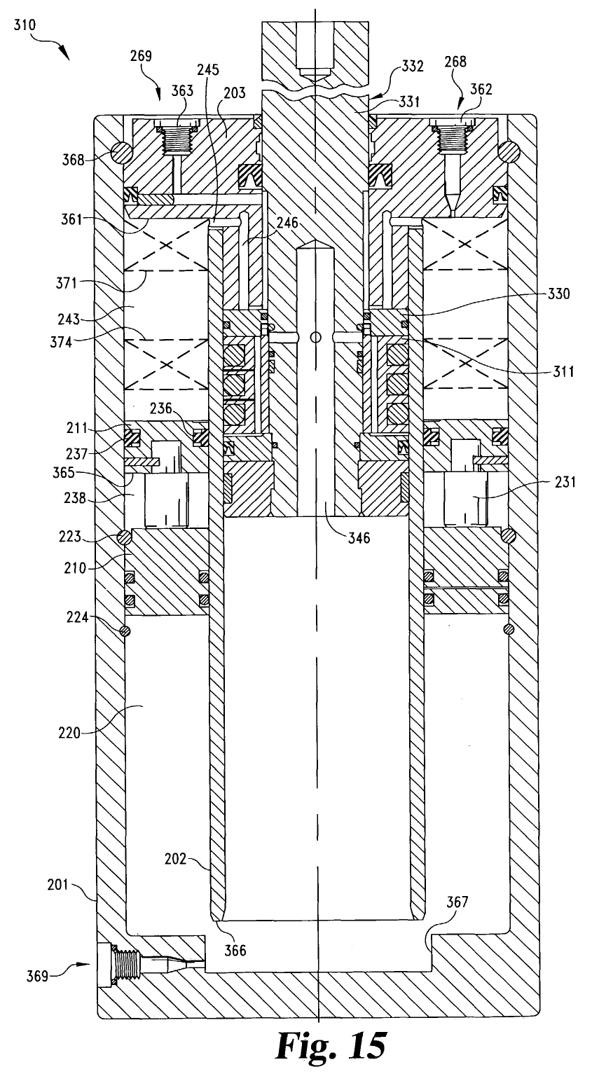

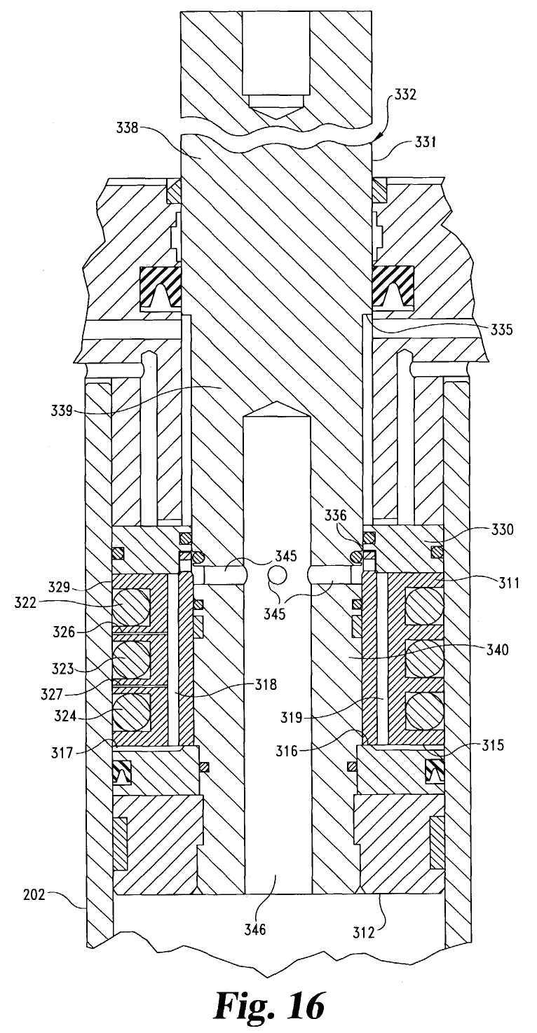

Referring to FIGS. 15-17, there is shown a soft-start, soft-return gas spring 310 in accordance with another embodiment of the present invention. Spring 310 is substantially identical to spring 200 of FIGS. 13 and 14, except for the configuration of the piston/rod assembly, floating ring and valve ring. The reference numbers relating to the piston/rod assembly, floating ring and valve ring in this embodiment of gas spring 310 will differ from those used for gas spring 200 of FIGS. 13 and 14, and all other reference numbers will remain the same. The operation of springs 200 and 310 are also substantially identical, and only the operation of spring 310 will be described herein. As shown in FIG. 16, the flange 288 (FIG. 14) and well 289 of valve ring 206 and piston 250 of spring 200 have been removed. Instead, valve ring 311 (FIG. 16) has a generally rectangular cross-section and a flat, annular bottom surface 315, and piston 312 has a generally flat, annular top surface 316 with an annular recess 317 defined therein. At least a portion of recess 317 is aligned below and in communication with at least one relief passageway (i.e. 318). Valve ring 311 is provided with three braking seals 322-324 instead of two, although more or fewer braking seals are acceptable so long as it or they exert the desired axially directed force resistive to axial movement of valve ring 311 within inner tube 202, as described herein. At least one small-diameter vent passageway (two shown at 326 and 327) extends radially through valve ring 311, between brake seal pairs 322/323 and/or 323/324 to provide fluid communication between at least one vent passageway (e.g. 318) and the outer surface 329 of valve ring 311.

In addition to FIGS. 15 and 16, FIG. 17 is provided to show an enlarged view of a portion of spring 310, focusing on the area of valve ring 311, floating ring 330 and piston rod 331, and with spring 310 in the extended, rest position. As with piston rod 249 and its ledges 263 and 265, piston rod 331 has first and second circumferential ledges 335 and 336 defined by the primary diameter portion 338 and the two, sequentially reduced diameter portions 339 and 340. A seal 341 is positioned within a recess 342, the upper surface of which intersects with ledge 336. The radial passageways 345 extend from central passageway 346 and exit piston rod 331 just below ledge 336, recess 342 and seal 341, as shown. A circumferential recess 347 is defined in piston rod 331 to coincide with the exiting of radial passageways 345.

Like valve ring 206 (FIGS. 13 and 14), the inner diameter of valve ring 311 is substantially the same as the outer diameter of piston rod 331 at reduced diameter portion 340. Valve ring 311 includes a generally cylindrical flange 350 that extends upwardly from the otherwise flat upper surface 351 of valve ring 311. The inner diameter of flange 350 is substantially equal to the outer diameter of piston rod 331 at reduced diameter portion 339, thereby creating a circumferential valve ring ledge 352 that will engage with ledge 336, as described herein. Flange 350 has a number of holes 353 defined therein for providing free fluid flow between the inside and outside cylindrical surfaces of flange 350. To accommodate cylindrical flange 350, a generally cylindrical recess 354 is defined in the lower, inside portion of float ring 330, as shown.

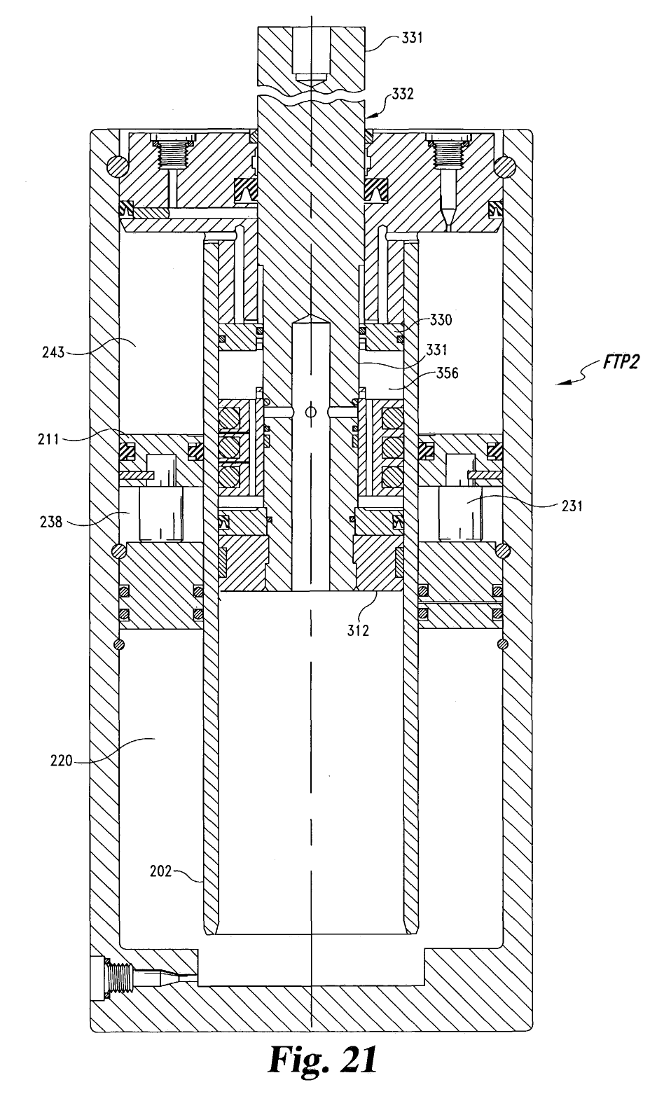

Just as gas spring 10 defines a relief chamber 60, gas spring 310 defines a relief chamber 356 (best seen in FIG. 21) that is defined and bounded by inner tube 202, piston rod 331, floating ring 330, and piston 312. As described herein, the volume of relief chamber 356 will vary depending on the position of piston/rod assembly 332. With piston/rod assembly 332 in the extended, rest position of FIGS. 15 and 16, relief chamber 356 is in communication with primary gas chamber 220 and is of neglible volume, primarily including recess 317 in piston top 316, the vent passageways (318, 319 and any others) and holes 353.

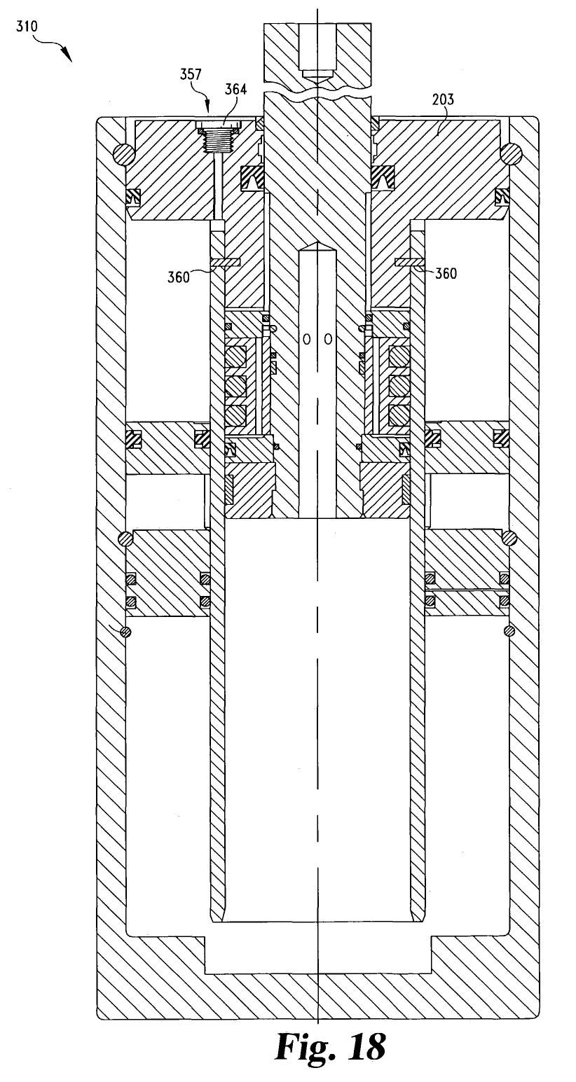

Referring to FIG. 18, spring 310 is shown rotated 45 degrees from the view in FIG. 15 and shows a vent port 357 provided in head plate 203 to facilitate assembly and charging of spring 310.

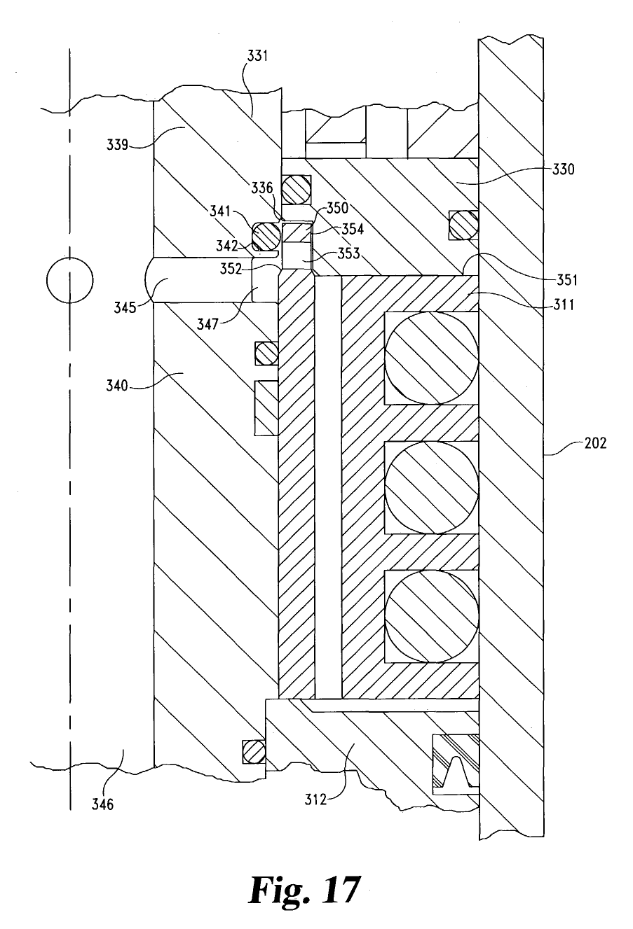

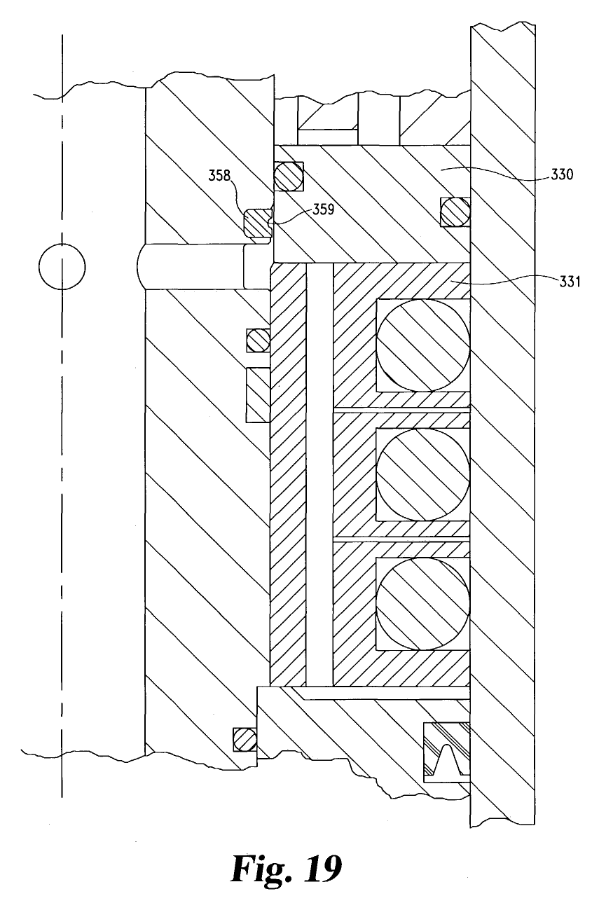

Referring to FIG. 19, there is shown an alternative embodiment of the configuration of FIG. 17 wherein flange 350 is removed from valve ring 311, and there is no recess 354 in floating ring 330. Also, the seal 341 of FIG. 17 is now seal 358, which has a circumferential groove 359 defined therein at its outer side. The configuration of FIG. 19 may be preferable for some dimensional versions of the gas springs described herein and may be preferable for some gas springs depending on the intended fluid operating pressures.

Generally, spring 310 is assembled and charged as follows:

Lower locking ring 224, outer chamber barrier 210 and upper locking ring 223 are positioned inside outer tube 201, as shown (FIG. 15). Valve ring 311, floating ring 330, piston/rod assembly 332, inner tube 202 and head plate 203 are assembled to the configuration shown in FIG. 15. Pins 360 (FIG. 18) secure head plate 203 to inner tube 202. Outer piston 211 is also assembled, over inner tube 202, and up against the bottom surface 361 of head plate 203. With the various plugs 362-364 (FIGS. 15 and 18) removed from their respective fill, relief and vent ports 268, 269 and 357, the assembled combination of valve ring 311, floating ring 330, piston/rod assembly 332, inner tube 202, head plate 203 and outer piston 211 is then inserted into outer tube 201 until the bottom 366 of inner tube 202 comes to rest at the bottom of well 367 that is defined in the bottom of outer tube 201. As outer piston 211 is inserted down into outer tube 201 and its seals 236 and 237 engage tubes 202 and 201, ambient air is allowed to escape via a vent such as at 357. Lock ring, 368 is then installed to lock head plate 203 in outer tube 201. Gas spring 310 is then charged at gas fill port 369 with nitrogen (N₂) to 2000 psi. This value and other values presented herein are according to one embodiment and to enable a better understanding of the invention. It should be understood that such values for this and all embodiments disclosed and suggested herein are based on rough dimensional estimates of the various compenents, and alternative embodiments are contemplated wherein component dimensions, fluid compositions and fill pressures are varied from those presented herein to produce different operating characteristics and output results.

Upon charging gas spring 310, the assembled combination of valve ring 311, floating ring 330, piston/rod assembly 332, inner tube 202, head plate 203 and outer piston 211 will be pushed up until head plate 203 engages with lock ring 368, such assembled combination being as shown in FIG. 15, with the exception of the position of outer piston 211, which is juxtaposed subjacent head plate 203, in a position represented at 317. With the N₂ charging, outer chamber barrier 210 will also be pushed up by the gas pressure therebelow until it engages lock ring 223, as shown. At this stage, with outer piston 211 directly under head plate 203 at 371, control gas chamber 238 contains air at roughly ambient pressure (14.7 psi). Vent 357 is then plugged (364). The air in control gas chamber 238 is thus trapped at ambient air pressure.

Oil is then injected through fill port 268 until the air therein is purged and oil starts to emerge from relief port 269. Port 269 is plugged (363). Oil is continued to be pumped in thru fill port 268, the oil flowing through passageways 246 and 245 and into outer oil chamber 243, pushing outer piston 211 down from its assembly position 371 until it contacts outer chamber barrier 210 and is in its base position, as shown in FIG. 15. As outer piston 211 moves from the assembly position 371 to the base position 365, the oil injection pressure at fill port 268 will rise from about 14.7 psi to about 64 psi as the gas in control gas chamber 238 is compressed. When pins 231 engage outer barrier 210, the oil injection pressure at fill port 268 will spike. That is, at that point, further injection of oil can occur only if floating ring 330, valve ring 311 and piston/rod assembly 332 (and/or outer chamber barrier 210) are forced down against the pressure of the N₂ gas, which is at about 2000 psi. The spiking oil pressure is the signal that the oil fill procedure is complete, and fill port 268 is capped (361).

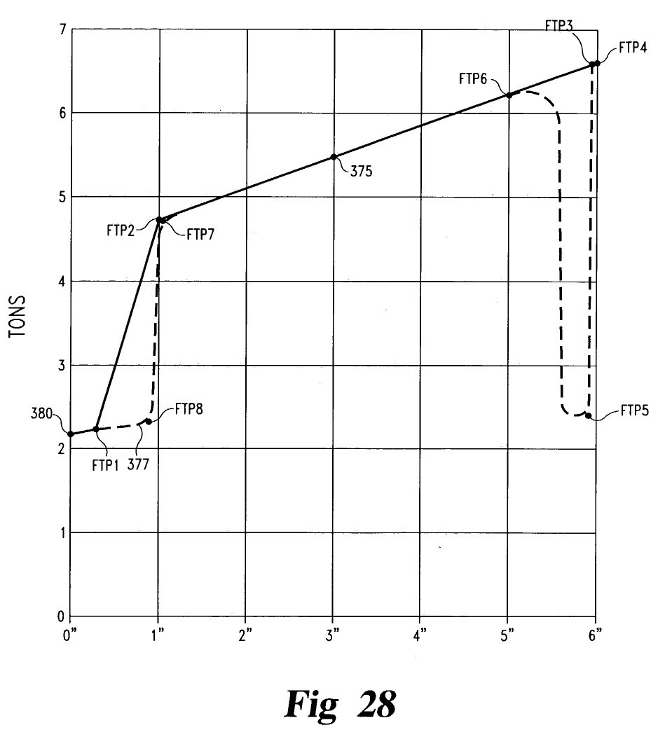

Gas spring 310 is now assembled, charged and ready for operation which, with particular reference to FIGS. 15 and 20-27 and the graph of FIG. 28, occurs as follows:

In the extended, rest position (FIGS. 15-17). The air pressure in control gas chamber 238 is at approximately 64 psi. The N₂ pressure in primary gas chamber 220, central passageway 346, radial passageways 345 and relief chamber 356 is at approximately 2000 psi. (relief chamber 356 is at its minimum, is in communication with primary gas chamber 220 and is of neglible volume, primarily including recess 317 in piston top 316, the vent passageways (318, 319 and any others) and holes 353.) The output force of piston rod assembly 332 in the extended, rest position is indicated at 380 in FIG. 28. Application of downward external force on piston/rod assembly 332 moves piston/rod assembly 332 to a first force transition position FTP1 wherein piston/rod 332 assembly has moved downwardly approximately 0.3 inches.

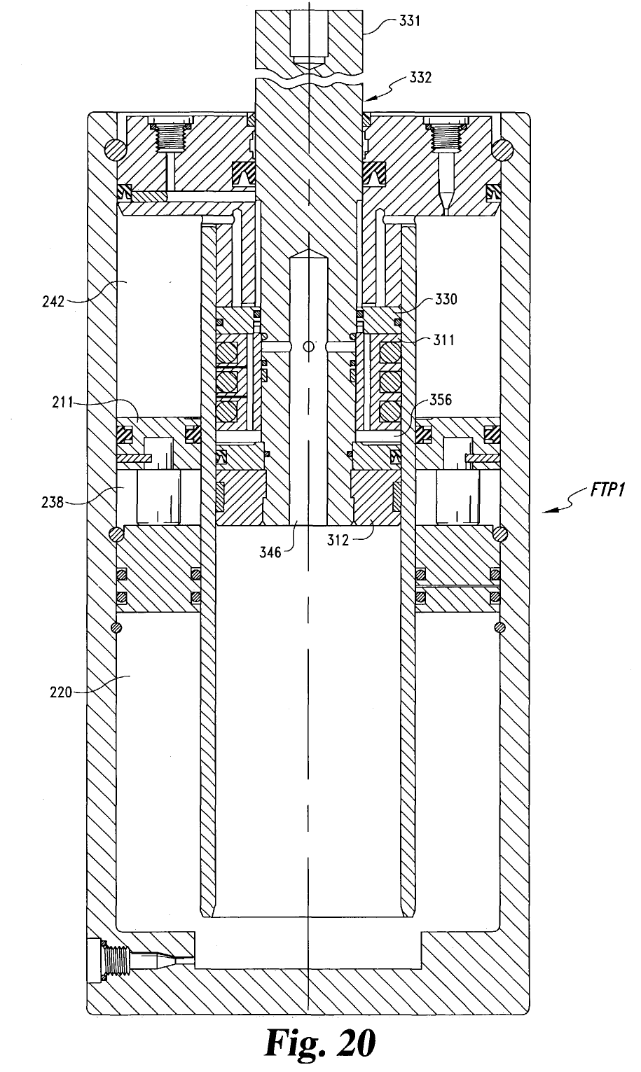

First force transition position FTP1 (FIG. 20). FfP1 is characterized in that second circumferential ledge 336 of piston rod 331 has just engaged with circumferential valve ring ledge 352 of valve ring 311, and further downward movement of piston/rod assembly 332 will thereby force valve ring 311 to move downwardly as a unit therewith. Also, the approximately 0.3 inch downward movement of piston/rod 332 has resulted in the engagement of valve ring 311 with the seal 341 and consequential sealing off of radial passageways 345. As a result, primary gas chamber 220 is now separate and distinct from relief chamber 356. Relief chamber 356 has increased in volume by the 0.3 inch gap between the bottom of valve ring 311 and the top of piston 312. The upwardly directed output force of piston/rod assembly 332 has increased slightly as represented at FTP1 in FIG. 28. At FTP1, the pressures in primary gas chamber 220 and relief chamber 356 are substantially identical. Continued movement of piston/rod assembly 332 (due to the application of sufficient downward force) moves piston/rod assembly 332 to a second transition position FTP2 (FIG. 21)

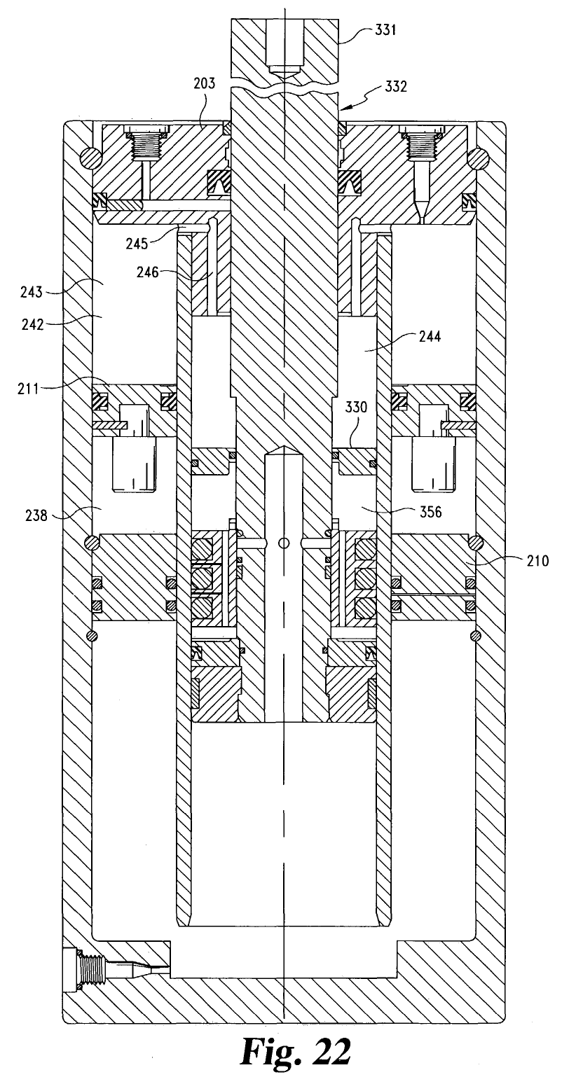

Second force transition position FTP2 (FIG. 21). FTP2 is characterized in that, with second circumferential ledge 336 of piston 331 engaged with valve ring ledge 352 of valve ring 311, piston/rod assembly 332 and valve ring 331 have now moved as a unit downwardly together approximately another 0.7 inches for a total downward movement of approximately one inch, and the output force of piston/rod assembly 332 is here indicated at FTP2 in FIG. 28. At this point, the volume of relief chamber 356 has now increased so that the gas pressure therein has decreased to a value approximately equal to the gas pressure of control chamber 238. Further downward movement of piston/rod assembly 332 would further decrease the pressure below floating ring 330, whereby the pressure exerted on the top of float ring 330 would be greater, and float ring 330 will move downwardly, as well. That is, as piston/rod assembly 332 is caused to move downwardly from FTP2, floating ring 330 will move downwardly from its initial position directly below head plate 203 to maintain equal forces both above and below floating ring 330. Thus, at FTP2, the gas pressure in control gas chamber 238 is approximately 64 psi, and the oil pressure above outer piston 211 will be just slightly less than 64 psi. (This is due to the four spacer pins 231. That is, the area of bottom side of outer piston 211 is slightly less than the area on the top side, and with equal forces acting both above and below outer piston 211, the oil pressure in outer oil chamber 243 acting above outer piston 211 must be just slightly less than the gas pressure in control gas chamber 238. The pressure difference acting on the top and bottom of outer piston 211 due to spacer pins 231 is insubstantial and inconsequential, and the pressures in chambers 238 and 243 will be considered to be equal for purposes of discussion herein.) As piston/rod 332 continues to move downwardly from FTP2 (FIG. 21) floating ring 330 will move accordingly downwardly from head plate 203, and outer piston 211 will rise from outer chamber barrier 210 as the pressures in control gas chamber 238, primary oil chamber 242 and relief chamber 356 are all substantially equivalent. Primary oil chamber 242 still comprises the volumes of outer oil chamber 243 and inner oil chamber 244, which has now grown substantially. Oil is freely moving between outer and inner oil chambers 243 and 244 through passageways 245 and 246. If there is a continued application of downward force, piston/rod assembly 332 will ultimately move to the third force transition position FTP3, as shown in FIG. 23. (FIG. 22 shows piston/rod assembly 332 roughly halfway down, or about three inches down in this embodiment).

Third force transition position FTP3 (FIG. 23). FTP3 is characterized in that piston/rod assembly 332 has moved downwardly from the extended, rest position its full intended stroke of approximately six inches to the retracted, compressed position, and the output force of piston/rod assembly 332 is here indicated at FTP3 in FIG. 28. The pressure in primary gas chamber 220 has risen to approximately 2,600 pounds, and the pressure in control gas chamber 238, primary oil chamber 242, and relief chamber 356 are all at approximately 32 psi. Floating ring 330 is positioned above valve ring 311 and close to, but below first circumferential ledge 335. This, the uppermost position of outer piston 211, is also indicated at 374 in FIG. 15. With reversal of the downward application of force to piston/rod assembly 332 (such as occurs at this stage in a stamping press operation as described above), piston/rod assembly 332 will be allowed to move up under the bias of the very high gas pressure in primary gas chamber 220. From FTP3 piston/rod assembly 332 moves up 0.060 inches to fourth force transition position FTP4.

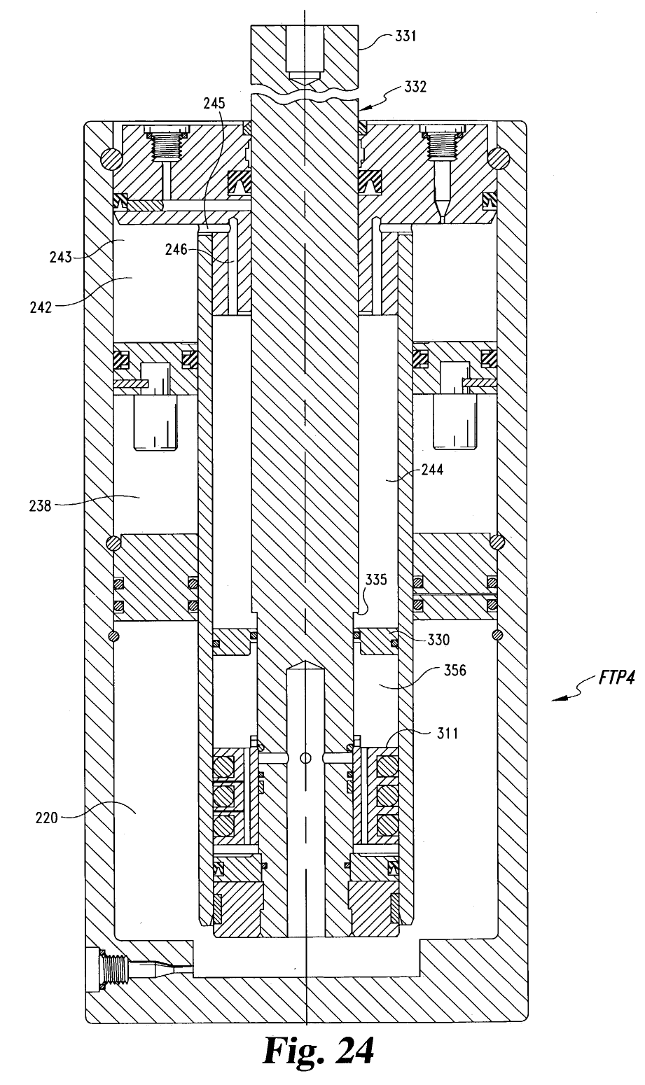

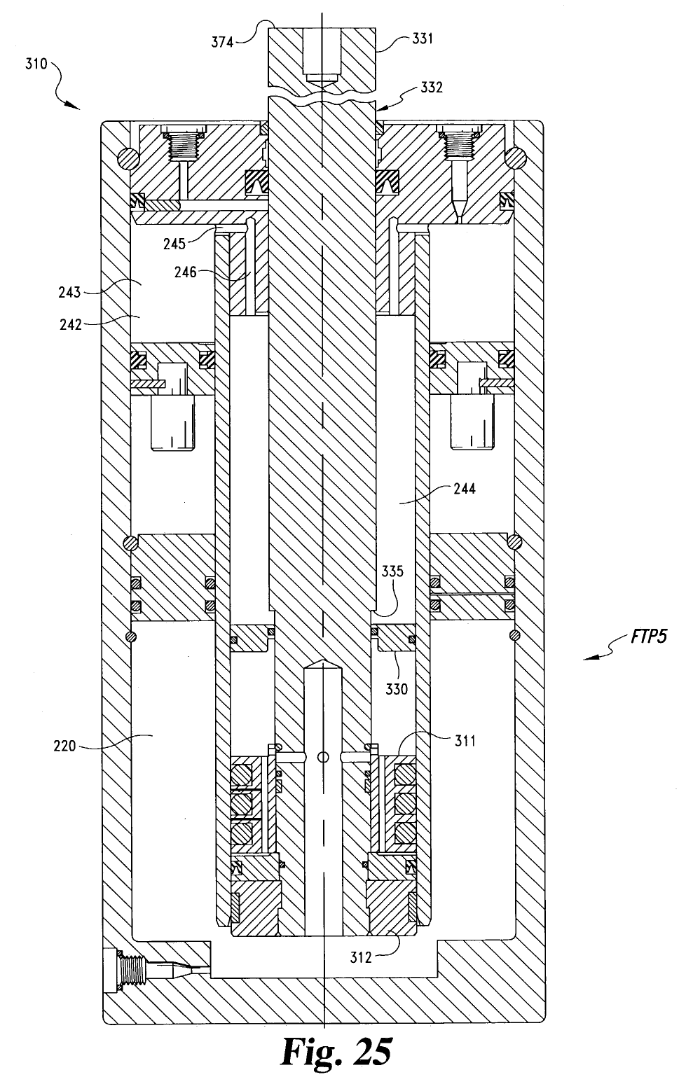

Fourth force transition position (FIG. 24). FTP4 is characterized in that piston/rod assembly 332 has moved up 0.06 inches. Breaking seals 322 through 324 resist such upward movement and valve ring 311 does not move. The pressure in chambers 220, 238, 242 and 356 change only infinitesimally from this 0.060 inch rise of piston/rod assembly 332. The output force at this point is indicated at FTP4 in FIG. 28. Continuing to move upward, piston/rod assembly 332 reaches the fifth force transition position FTP5, as shown in FIG. 25.

Fifth force transition position (FIG. 25). FTP5 is characterized in that piston/rod 332 has now moved up sufficiently relative to valve ring 311 so that second circumferential ledge 336 has disengaged from valve ring ledge 352, seal 341 has disengaged from valve ring 311 and passageways 345 have come in communication with relief chamber 356. Before disengagement of seal 341 from valve ring 311, the pressure in relief chamber 356 was approximately 32 psi and the pressure in primary gas chamber 220 and radial passageways 345 was approximately 2,575 psi. Thus, after disengagement of seal 341 from valve ring 311 an enormous burst of pressure surges from passageways 345 into relief chamber 356. As a result, the sudden high pressure gas burst forces valve ring 311 downwardly until it engages the top of piston 312, and floating ring 330 is forced upwardly until it engages with and is stopped by the first circumferential ledge 335. Because the oil in inner oil chamber 244 cannot instantaneously travel through passageways 246 and 245 into outer oil chamber 243, there is a slight delay before floating ring 330 rises up and is stopped by ledge 335. During this delay, the pressure both above and below valve ring 311 is substantially equal, and the output force to piston/rod assembly 332 is equal to the pressure in primary gas chamber 220 times only the area of piston rod 311. That is, for a moment the output force to piston/rod assembly 332 drops to the value indicated at FTP5 in FIG. 28. This momentary drop in output force from gas spring 310 significantly lessens the impact that gas springs customarily deliver to a press at the change of direction of the ram. The time it takes for floating ring 330 to move from its position at FTP5 up to ledge 335 depends in part on the viscosity of oil in primary oil chamber 242 and the metering effect of passageways 245 and 246. That is, enlarging or decreasing the size and length of passageways 245 and 245 can speed up or delay the movement of floating ring 330, and thus the time that elapses for the output force of piston/rod assembly 332 to return to its high value as next discussed.

As floating ring 330 quickly rises to ledge 335, piston/rod assembly 332 has also been continuing to rise (as it is allowed to do so the by still rising press ram engaged at the top 374 thereof). With further upward movement, the output force of piston/rod assembly 332 moves to FTP6, as indicated in FIG. 28.

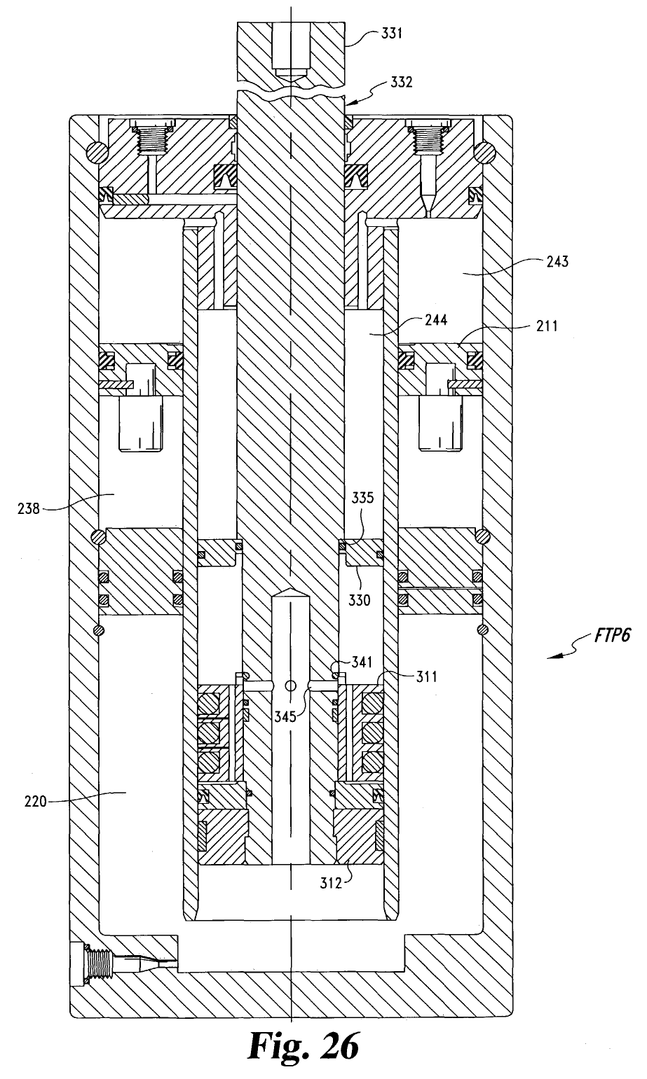

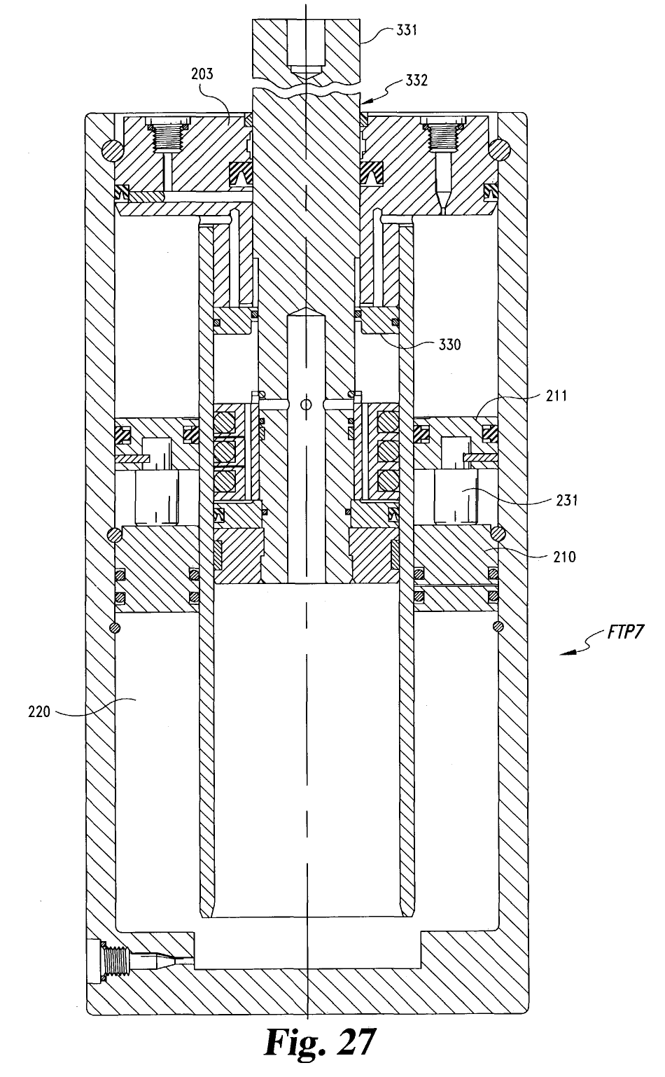

Sixth forced transition position FTP6 (FIG. 26). FTP6 is characterized in that valve ring 311 is positioned against the top of piston 312 where it will stay for the majority of the rest of upward movement of piston/rod assembly 332. Because seal 341 is disengaged from radial passageways 345, the pressure below floating ring 330 is the same as in primary gas chamber 220 at approximately 2550 psi. The pressure exerted on the bottom of floating ring 330 at approximately 2550 psi is vastly greater than the pressure exerted above floating ring 330 at about 37 psi, and floating ring continues to be seated up against ledge 335. Consequently, the output force of piston/rod assembly 332 (the pressure in primary gas chamber 220 times the combined area of piston rod 331 and floating ring 330) remains at the high level as indicated at FTP6 in FIG. 28. Continued upward movement of piston/rod assembly 332 will primarily result in an increase in volume in primary gas chamber 220 and a consequential decrease in pressure therein. As before, the output force corresponding to this pressure will be lessened somewhat by the back pressure from control gas chamber 238 which, because piston/rod assembly 332 and floating ring 330 (which is lodged up against ledge 335) are moving up, causes oil to flow from inner oil chamber 244 to outer oil chamber 243, which causes outer piston 211 to drop and increase the pressure in control gas chamber 238. Representatively, the position of the various elements of gas spring 310 are shown with piston/rod assembly 332 having risen three inches from FTP3 (its lowermost position) is shown in FIG. 27. The output force of piston/rod assembly 332 at three inches up is indicated in the graph of FIG. 28 at 375. After further movement, piston/rod assembly 332 reaches a seventh force transition position FTP7.

Seventh force transition position FTP7 (FIG. 27). FTP7 is characterized in that piston/rod assembly 332 has risen approximately 5.1 inches from FTP3 (its bottommost position or nadir) wherein floating ring 330 has come to rest against the bottom of head plate 203, and outer piston 211 has reached its bottom position with its spacer pins 231 engaging with outer chamber barrier 210. The output force of piston/rod assembly 332 is indicated generally at FTP7 in FIG. 28. Because floating ring 330 no longer moves, the output force of piston/rod assembly 332 as piston/rod assembly 332 continues to move upward is now reduced to the pressure of primary gas chamber 220 times just the area of piston rod 311, and the output force is thereafter indicated generally at FTP8 until piston/rod assembly 332 rises to the extended, rest position. The output force is thereafter indicated at 380.

Alternative embodiments are contemplated wherein the fluid in primary oil chamber 242 is other than oil.

Referring to FIGS. 29-34, there is shown a soft-start, soft-return gas spring 400 in accordance with another embodiment of the present invention. Spring 400 is similar to spring 310, and similar reference numbers will be used where possible. Gas spring 400 generally includes a first or outer tube 401; a second or inner tube 402; a head plate 403; a base plate 404; a piston/rod assembly 405 that includes a piston rod 406 and an inner, sliding piston 407; an axis 408; an outer chamber barrier 410; an outer piston 411; a split valve ring retainer 412; a fixed valve ring 413; and, various seals, wear bands, scrapers, snap rings, and lock rings as are commonly known to properly assemble and seal such gas and/or hydraulic springs and cylinders, some of which are specifically identified herein. All such seals, wear bands, scrapers, snap rings, and lock rings are contemplated as being inherently included in the parts that holds them to provide proper sealing, wear and positionment among the various components of the spring 400 and all other springs contemplated herein.

Piston rod 406 has a primary diameter portion 416 and a reduced diameter portion 417, the transition of which defines a circumferential ledge 418. A piston retainer comprises two halves that meet at a diametrical plane passing through axis 408 and that together form a toroidal-shaped ring 419 that surrounds piston rod 406 at the reduced diameter portion 417. Ring 419 is held in position between piston rod 406 and inner tube 402 and by engagement within a complimentary shaped recess 420 in piston rod 406. Ledge 418 and the upper surface 421 of piston retainer 419 define upper and lower stops (418 and 421), which define an inner trap 423. As described below, trap 423 defines the upper and lower limits, respectively, of travel of piston 407 relative to piston rod 406.

Piston 407 is a toroidal-shaped ring that surrounds piston rod 406 for sliding movement between ledge 418 and upper surface 421. Split piston retainer 419 is provided with one or more passageways 424 that extend all the way through from its top surface 421 to its bottom surface 425 to provide complete fluid communication between chambers above and below piston retainer 419. Sliding piston 407 is provided with inner and outer seals 426 and 427, respectively, that are like seals 236 and 237 (FIG. 13) in that they are selected with characteristics, not to provide a certain breaking action, but rather to exert as little resistance to movement of sliding piston 407 as possible, while at the same time providing sufficient sealing action to prevent fluid flow between the chambers above and below sliding piston 407. At least a portion of the upper surface 428 of piston 407 is configured for sealing engagement with a portion 429 of the bottom of head plate 403, as shown.

Head plate 403 defines central opening 430, through which telescopically reciprocates piston rod 406. Head plate 403 also defines one or more valve passageways 432 that provide communication between the inside of inner tube 402 (at first opening 433), and the outside (at second opening 434), proximal to fixed valve ring 413, as described herein. At its top, inner tube 402 defines an inner, annular recess 431 that is in communication with first opening(s) 433. When piston rod 406 is in its extended, rest position, as shown in the right half of FIG. 29, the sealing surfaces 428 and 429 are engaged, and a soft-start chamber 435 is defined and bounded by piston rod 406, head plate 403 and sliding piston 407, just below ledge 418. Also, in the extended, rest position sealing surfaces 428 and 429 are in sealing engagement to block fluid flow through passageway(s) 432 and into or out of soft-start chamber 435. Embodiments are contemplated wherein the valve passageway 432 is defined entirely in headplate 403, entirely in inner tube 402 or in a combination of the two, as is the case in the present embodiment with passageway 432 in combination with recess 431. In this combination, first opening 433 is more precisely at recess 431, which is opened and closed off by piston 407, as described herein.

Inner tube 402 is connected to head plate 403 in any appropriate manner such as by pressure fit and/or radially extending pins and/or other means well known in the art.

Both outer chamber barrier 410 and valve ring retainer 412 comprise split rings that are assembled around inner tube 402, disposed within recesses 436 and 437, respectively, and are thereby fixedly held between inner tube 402 and outer tube 401 to define upper and lower stops (412 and 410). These stops (412 and 410) define an outer trap 444, which defines the upper and lower limits of movement of outer piston 411. Each of chamber barrier 410 and valve ring retainer 412 define one or more holes 438 and 439, respectively, that freely permit the passage of fluid from chambers above and below. Outer chamber barrier 410 and retainer 412 are each contemplated to comprise configurations other than a ring, for example and without limitation, one or more rods radially extending from inner tube 402 or one or more simple ledges extending outwardly from inner tube 402 or inwardly from outer tube 401. Also, barrier 412 may be eliminated entirely, and fixed valve ring could be secured in position relative to head plate 403 by other means, such as a snap ring seated in a groove in inner tube 402. Like outer piston 211 (FIG. 15), outer piston 411 is a generally toroidal-shaped ring with inner and outer seals 442 and 443 that are of the same type as seals 426 and 427.

Referring to FIGS. 29-33, fixed valve ring 413 is a toroidal-shaped ring that is disposed between outer and inner tubes 401 and 402 and between head plate 403 and valve ring retainer 412. Fixed valve ring 413 includes an upper surface 445, a lower surface 446, an inner, cylindrical surface 447, and an outer cylindrical surface 448. Fixed valve ring 413 is thus sized and shaped for a close, coaxial fit between inner tube 402 and outer tube 401, as shown. Appropriate seals 451 and 452 are provided in recesses defined in the inner and outer surfaces 447 and 448, respectively.

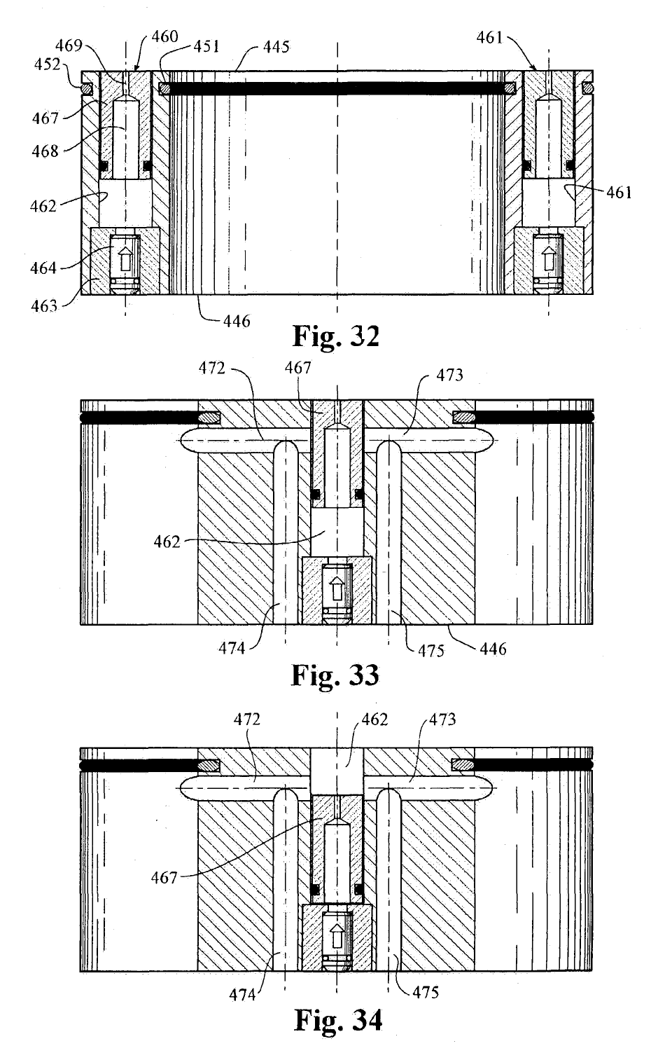

Fixed valve ring 413 is provided with a pair of diametrically opposed check valve assemblies 453 and 454 that are configured to provide fluid flow only in the upward direction, as shown by the arrows in FIGS. 29 and 31. Each check valve assembly 453 and 454 includes a commercially available cartridge check valve 455 and 456. Offset 90 degrees therefrom about central axis 408, fixed valve ring 413 includes a pair of identical, diametrically opposed flow control assemblies 460 and 461, only one of which will be described. Flow control assembly 460 includes a valve ring passageway 462 defined in fixed valve ring 413 to extend vertically from the bottom surface 446 to the top surface 445. A plug 463 is tightly disposed in a lower, larger diameter section of passageway 462 and defines its own passageway for receipt of a commercially available cartridge check valve 464. Check valve 464 is configured to permit fluid flow only in the upper direction, as shown by the arrows in FIGS. 29 and 32. Above plug 463 and check valve 464, a sliding piston or poppit 467 is received for vertical sliding reciprocation within passageway 462. Poppit 467 defines its own central, restricted flow passageway 468 extending axially completely therethrough. Passageway 468 is restricted flow in that it has a small diameter over a portion of its length (at 469) to provide metered fluid flow therethrough. The diameter and length of reduced passageway 469 is set to provide the desired extent of metered fluid flow to cause gas spring 400 to operate as desired. Again, appropriate seals are provided wherever necessary to restrict or prevent fluid flow. Fixed valve ring 413 is securely and fixedly positioned up against the bottom of head plate 403 by split valve ring retainer 412. The vertical movement of poppit 467 is thus restricted between an upper position up against head plate 403 and a lower position down against plug 463.

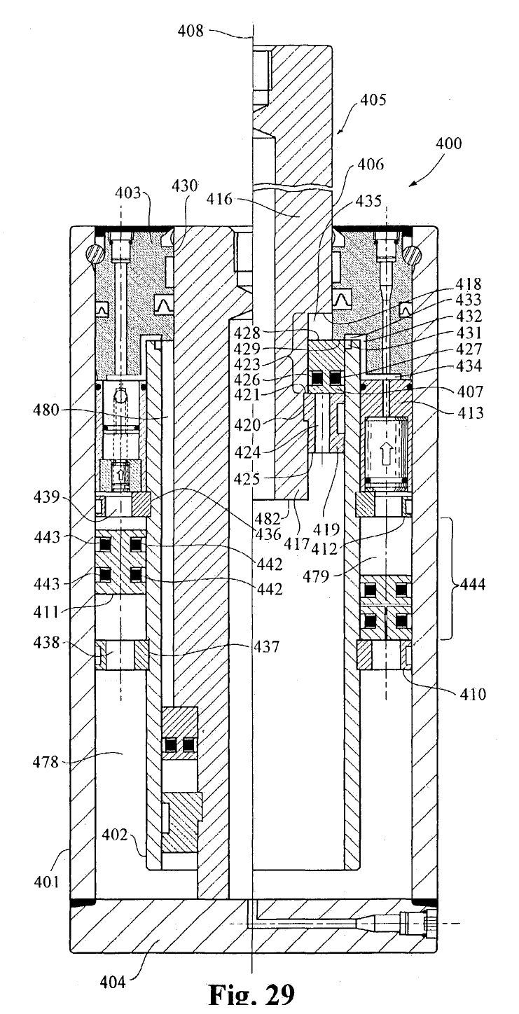

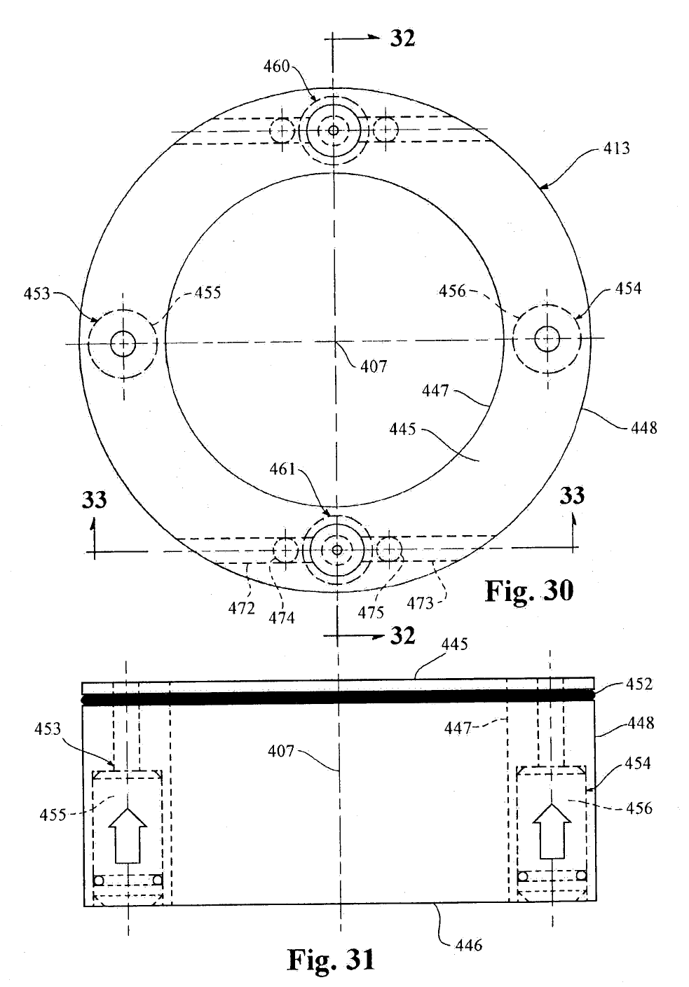

Referring to FIGS. 30 and 33, flow control assembly 460 further includes fixed valve ring 413 defining, one and preferably two horizontal bypass passageways 472 and 473 that intersect with and extend in opposite directions from passageway 462, as shown. Flow control assembly 460 further includes fixed valve ring 413 defining one and preferably two bypass passageways 474 and 475 extending from the bottom surface 446 up to and intersecting with horizontal passageways 472 and 473, thereby providing communication between the chamber below fixed valve ring 413 and central passageway 462. When poppit 467 is in the upper, closed position, horizontal passageways 472 and 473 are blocked, and fluid flow is precluded from flowing through flow control assembly 460, at least through passageways 472-475, as shown in FIG. 33. When poppit 467 is in the down, open position, fluid flow is unrestricted in either direction through flow control assembly 460 via passageways 472-475 and 462, as shown in FIG. 34.

In assembly, gas spring 400 has a primary gas chamber 478 that is defined by outer tube 401, inner tube 402, outer piston 411, inner piston 407 and piston rod 406; an outer oil chamber 479 defined by outer tube 401, inner tube 402, outer piston 411, and head plate 403; and, an inner oil chamber 480 defined by inner tube 402, inner piston 407, piston rod 406 and head plate 403.

In use with devices such as a stamping press, the soft-start feature is designed to abate the severe shock that occurs when die binders impact during the high speed part of the press downstroke. The soft-start is accomplished by allowing the piston rod 406 to initially slide downwardly, without piston 407. The output force of piston rod 406 is thus only the pressure in gas chamber 478 times the area of piston rod 406 at the reduced diameter portion 417. For the embodiment shown in FIG. 29, this initial downward movement of piston rod 406 is one half inch, that is, the height of soft-start chamber 435.

Outer piston 411 serves as a separator between the nitrogen gas below it in primary gas chamber 478 and the oil above it in outer oil chamber 479. The nitrogen gas pressure provides the output force for piston rod 406, and the oil in outer and inner oil chambers 479 and 480 controls a portion of those output forces. The oil in outer oil chamber 479 above outer piston 411 is generally in communication with the oil in inner oil chamber 480, and fixed valve ring 413 and piston 407 cooperate to control the flow of oil between oil chambers 479 and 480. As piston rod 406 vertically reciprocates, the movement of oil between outer and inner oil chambers 479 and 480, respectively, must pass through fixed valve ring 413 and valve passageway(s) 432. Valve ring 413 permits free flow of oil from outer oil chamber 479 to inner oil chamber 480 during the downstroke of piston rod 406, but initially precludes oil flow during upstroke. At the start of upstroke, the oil in outer chamber 479 can only displace through the poppit/check valved, flow control assemblies 460 and 461.

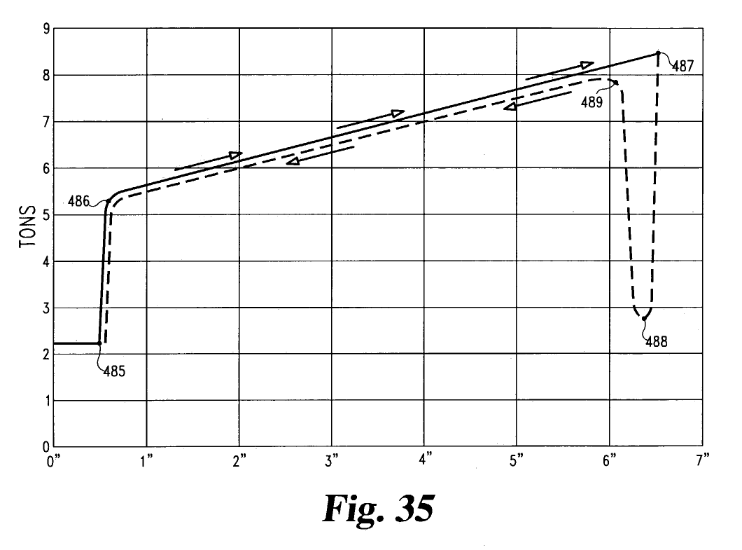

In more specific detail, gas spring 400 operates as follows. At the start of the downstroke (as shown in the right half of FIG. 29), the one half inch high soft-start chamber 435 is essentially a vacumn because the oil ports were sealed one half inch before piston rod 406 extended to full out, and the remaining one half inch upward travel of piston rod 406 created soft-start chamber 435 with essentially no fluid flowing thereinto. This one half inch high soft-start chamber 435 contributes essentially no force to the piston rod output during the first one half inch of downstroke. The output force of piston rod 406 is therefore equal to the gas pressure of primary gas chamber 478 times the area of piston rod 406 at the reduced diameter portion 417. In one embodiment, this translates to 2000 psi times the area of the bottom end 482 of piston rod 406, which equals 2000×2.27=2.27 tons (at 485 in FIG. 35).

At one half inch down, ledge 418 engages piston 407, and the two move downwardly therefrom as a unit. Output force of piston rod 406 immediately increases from gas pressure times the area of face 482 to gas pressure times the area of the entire piston/rod assembly 405 (that is, the area of face 482 plus the area of piston 407 or the inner cross-sectional area of inner tube 402). In the embodiment of FIG. 29, the output force jumps from approximately 2.27 tons to approximately 5.31 tons (at 486). As piston 407 begins to move downwardly from its seat up against surface 429, the opening 403 of valve passageway 432 is uncovered. Pressure in primary gas chamber 478 acting on the bottom of outer piston 411 forces oil in outer oil chamber 479 freely up through fixed valve ring 413, through valve passageway(s) 432 and into the growing inner oil chamber 480 as piston rod 406 moves downwardly. As piston rod 406 moves to its retracted compressed position (left half of FIG. 29) the piston rod output force increases to approximately 8.44 tons (at 487). During the downstroke, as oil flows upwardly through fixed valve ring 413, poppit valves 467 are urged to their upward position, as shown in FIG. 32.

A purpose of the present invention is to create a soft-return, that is a large force reduction instantly at the start of the upstroke to eliminate the aforementioned press drive damage, and then to quickly revert back to a reciprocal of downstroke forces for the remainder of the upstroke. At the start of the upstroke, that is when a downward force is removed from the top of piston rod 406, piston rod 406 is biased to move upwardly, which urges oil in inner oil chamber 480 up and out through valve passageway(s) 432 and back into outer oil chamber 479. However, fixed valve ring 413 will not permit oil to flow through check valve assemblies 453 and 454 nor through smaller check valve cartridges 464. Because there is now greater pressure being exerted on the top of poppit valves 467, the poppit valves 467 will be urged downwardly as oil between poppit valves 467 and plugs 463 moves slowly up through reduced passageways 469. This momentary spike in pressure in inner oil chamber 480 acts downwardly on piston 407 and against the upward force of the gas pressure in primary gas chamber 478. The resulting output force of piston rod 406 is instantaneously reduced (at 488). Poppits 467 move downwardly approximately one quarter inch until the top of poppits 467 fall to and just below horizontal passageways 472 and 473, whereupon oil then freely flows therethrough and down into outer oil chamber 479. At this point, the pressure spike in inner oil chamber 480 is relieved, and the output force on piston rod 406 returns substantially back up to its previous value (at 489). For the remainder of the upstroke, the output force of piston rod 406 reverts back to a reciprocal of the downstroke until piston 407 engages with sealing face 429, whereupon the output force drops back down to rod-only force (that is, gas pressure times the area of piston face 482) (at 485).

The ideal condition for gas die springs is to have any energy generated during the downstroke to be essentially expelled during upstroke since the majority of the difference between input and output energy is otherwise generated in the form of heat, which must be dissipated by the surrounding system. The present invention is believed to provide the desired soft-start and soft-return features while generating as little output heat energy as possible.

Alternative embodiments are contemplated wherein the soft-start, soft-return gas springs 10, 200, 310 and 400 are used in machines other than the press disclosed here, and gas spring 400 is contemplated for use in a manifold in a manner similar to that shown and described for other embodiments presented herein.

Piston retainer 419 functions both to provide a lower limit of travel for piston 407 and to stabilize the axial movement of piston rod 406. Other structure is contemplated to perform either or both of these functions. For example, and without limitation, piston retainer 419 could simply be a small ledge, extending radially outwardly from piston rod 406 just enough to engage and stop downward movement of piston 407, but not enough to engage inner tube 402. It is not necessary that the piston retainer extend all the way round piston rod 406 nor all the way to inner tube 402.

Likewise, outer chamber barrier 410 and valve ring retainer 412 are contemplated to have structure other than that disclosed herein. The primary purpose of outer chamber barrier 410 is to define the lower limit of travel of outer piston 410, and any other structure that appropriately performs this function is contemplated. The primary purpose of valve ring retainer 412 is to hold fixed valve ring 413 in the desired position around inner tube 402 and up against head plate 403, and any other structure that appropriately performs this function is contemplated.

The terms oil and oil chamber as used herein are intended to include any appropriate hydraulic fluid.

While the invention has been illustrated and described in detail in the drawings and foregoing description, the same is to be considered as illustrated and not restrictive in character, it being understood that only the preferred embodiment has been shown and described and that all changes and modifications that come within the spirit of the invention are desired to be protected.

What is claimed is:

1. A gas spring, comprising:
an outer tube having a top and a bottom and being closed off at the bottom;
a head plate connected to the top of said outer tube and defining a central opening;
an inner tube having a top and a bottom and mounted to extend downwardly from said head plate within said outer tube;
a piston rod extending coaxially from within said inner tube, through the central opening in said head plate and outwardly of said head plate, said piston rod defining an inner trap and being mounted to reciprocate between a retracted, compressed position and an extended, rest position;
an inner piston having a top and a bottom and being disposed coaxially between said inner tube and said piston rod to reciprocate within the inner trap;
elements connected with at least one of said inner and outer tubes to define an outer trap;
an outer piston having a top and a bottom and being disposed coaxially between said inner tube and said outer tube for vertical reciprocation within the outer trap;
wherein said outer tube, inner tube, outer piston, inner piston and piston rod define a primary gas chamber;
wherein said outer tube, inner tube, outer piston and head plate define an outer oil chamber;
wherein said inner tube, inner piston, piston rod and head plate define an inner oil chamber;
wherein at least one of said head plate and said inner tube defines a valve passageway extending between the outer oil chamber and the inner oil chamber, the valve passageway including a first opening to the inner oil chamber and a second opening to the outer oil chamber;
a valve member disposed proximal the valve passageway and operable to variably control fluid flow between the inner oil chamber and the outer oil chamber;
wherein the inner trap includes said inner piston having an upper position closing off the valve passageway; and,
seals for preventing undesired fluid flow from the primary gas chamber, inner oil chamber and outer oil chamber.

2. The gas spring of claim 1 wherein said piston rod has a primary diameter portion and a reduced diameter portion and said inner piston is a toroidal-shaped ring that surrounds said piston rod at the reduced diameter portion.

3. The gas spring of claim 2 wherein the inner trap is at the reduced diameter portion and defines the limits of movement of said inner piston.

4. The gas spring of claim 1 wherein the outer trap includes at least one stop member connected with at least one of said inner tube and said outer tube, and the outer trap defines the limits of movement of said outer piston.

5. The gas spring of claim 1 wherein the valve passageway includes a recess defined in the top of said inner tube.

6. The gas spring of claim 1 wherein the valve passageway includes a passageway defined in said head plate.

7. The gas spring of claim 1 wherein said valve member includes at least one check valve assembly that includes a check valve permitting fluid flow only from the outer oil chamber to the inner oil chamber.

8. The gas spring of claim 1 wherein said valve member includes at least one flow control assembly juxtaposed proximal the valve passageway and being for modulating the rate of fluid flow from the inner oil chamber to the outer oil chamber.

9. The gas spring of claim 1 wherein said valve member is a valve ring disposed between said inner tube and said outer tube, the valve ring including a check valve assembly permitting fluid flow only from the outer oil chamber to the inner oil chamber and a flow control assembly for modulating the rate of fluid flow from the inner oil chamber to the outer oil chamber.

10. The gas spring of claim 9 wherein the flow control assembly defines a valve ring passageway extending between the valve passageway of said head plate and the outer oil chamber, and includes a poppit disposed for vertical reciprocation in the valve ring passageway.

11. The gas spring of claim 10 wherein the poppit defines a restricted flow passageway and the valve ring defines at least one bypass passageway extending from the restricted flow passageway to the outer oil chamber, and wherein the poppit has an upper, closed position blocking fluid flow between the valve ring passageway and the outer oil chamber and a down, open position permitting fluid flow between the inner and outer oil chambers through the valve passageway, valve ring passageway and bypass passageway.

12. The gas spring of claim 1 further including a manifold having at least one port sized and configured to connect with said first tube whereby said manifold is in communication with the primary gas chamber and wherein the bottom of said outer tube is closed by being connected to said manifold.

13. A soft-start, soft-return gas spring, comprising:
an outer tube having a top and a bottom that is closed off;
a head plate connected to the top of said outer tube and defining a central opening;
an inner tube mounted to extend downwardly from said head plate;
a piston rod extending through the central opening, having an inboard end in said inner tube, having an outboard end extending upwardly of said head plate, and operating to reciprocate between an extended, rest position and a retracted, compressed position, movement toward the retracted, compressed position being a downstroke and movement toward the extended, rest position being an upstroke;
an inner piston disposed between said piston rod and said inner tube;
an outer piston disposed between said inner tube and said outer tube;
a primary gas chamber defined by said outer tube, inner tube, outer piston, inner piston and piston rod;
an outer oil chamber defined by said outer tube; inner tube; outer piston and head plate;
an inner oil chamber defined by said inner tube; inner piston, piston rod and head plate;
valve passageway means for providing communication between said inner oil chamber and said outer oil chamber;
seals for preventing undesired fluid flow from said primary gas chamber, inner oil chamber and outer oil chamber;
first valve means for blocking fluid flow through the valve passageway when said piston rod is near the extended, rest position; and,
second valve means for regulating fluid flow in the valve passageway, said valve means permitting substantially free flow from said outer oil chamber to said inner oil chamber and regulating flow from said inner oil chamber to said outer oil chamber to between at least a first and a second flow rate.

14. The gas spring of claim 13 wherein said first valve means includes said piston rod defining an inner trap that defines the vertical limits of movement of said inner piston relative to said piston rod.

15. The gas spring of claim 14 wherein said inner trap includes said inner piston having an upper position closing off the valve passageway.

16. The gas spring of claim 15 wherein the inner trap includes said piston rod having a reduced diameter section around which said inner piston is disposed.

17. The gas spring of claim 13 wherein said valve passageway means includes at least one of said head plate and said inner tube defining a valve passageway extending between the outer oil chamber and the inner oil chamber, the valve passageway including a first opening to the inner oil chamber and a second opening to the outer oil chamber.

18. The gas spring of claim 13 wherein said valve passageway means includes said head plate defining a valve passageway extending between the outer oil chamber and the inner oil chamber, the valve passageway including a first opening to the inner oil chamber and a second opening to the outer oil chamber.

19. The gas spring of claim 18 wherein said inner tube has a top and said valve passageway means includes a recess defined in the top of said inner tube, the recess being in communication with the valve passageway and said inner oil chamber.

20. The gas spring of claim 19 wherein said first valve means includes said piston rod defining an inner trap that defines the vertical limits of movement of said inner piston relative to said piston rod and that includes said inner piston having an upper position closing off the first opening and the recess.

21. The gas spring of claim 13 wherein said first valve means regulates fluid flow in said passageway means as a function of the position of said piston rod.

22. The gas spring of claim 13 wherein said second valve means regulates fluid flow in said passageway means as a function of the direction of travel of said piston rod.

23. The gas spring of claim 13 wherein said second valve means includes at least one check valve assembly that includes a check valve permitting substantially free fluid flow from the outer oil chamber to the inner oil chamber.

24. The gas spring of claim 13 wherein said valve passageway means includes at least one of said head plate and said inner tube defining a valve passageway extending between the outer oil chamber and the inner oil chamber, the valve passageway including a first opening to the inner oil chamber and a second opening to the outer oil chamber, and wherein said second valve means includes at least one flow control assembly juxtaposed proximal the valve passageway and being for regulating the rate of fluid flow from the inner oil chamber to the outer oil chamber.

25. The gas spring of claim 13 wherein said valve passageway means includes at least one of said head plate and said inner tube defining a valve passageway extending between the outer oil chamber and the inner oil chamber, the valve passageway including a first opening to the inner oil chamber and a second opening to the outer oil chamber, and wherein said valve member is a valve ring disposed between said inner tube and said outer tube, the valve ring including a check valve assembly permitting fluid flow only from the outer oil chamber to the inner oil chamber and a flow control assembly for regulating the rate of fluid flow from the inner oil chamber to the outer oil chamber.

26. The gas spring of claim 25 wherein the flow control assembly defines a valve ring passageway extending between the valve passageway of said head plate and the outer oil chamber, and includes a poppit disposed for vertical reciprocation in the valve ring passageway.

27. The gas spring of claim 26 wherein the poppit defines a restricted flow passageway and the valve ring defines at least one bypass passageway extending from the restricted flow passageway to the outer oil chamber, and wherein the poppit has an upper, closed position blocking fluid flow between the valve ring passageway and the outer oil chamber and a down, open position permitting fluid flow between the inner and outer oil chambers through the valve passageway, valve ring passageway and bypass passageway.

28. The gas spring of claim 13 further including a manifold having at least one port sized and configured to connect with said first tube whereby said manifold is in communication with the primary gas chamber and wherein the bottom of said outer tube is closed off by being connected to said manifold.
